(19) United States
(12) Patent Application Publication
(10) Pub. No.: US 2003/0127258 A1
(43) Pub. Date: Jul. 10, 2003

(54) Load-shifting vehicle

(76) Inventor: John B. Lansberry, Woodland, PA (US)

Correspondence Address: PILLSBURY WINTHROP, LLP, P.O. BOX 10500, MCLEAN, VA, 22102, US

(21) Appl. No.: 10/206,866

(22) Filed: Jul. 29, 2002

Related U.S. Application Data
(63) Continuation-in-part of application No. 09/984,647, filed on Oct. 30, 2001, now Pat. No. 6,425,450.
(60) Provisional application No. 60/309,879, filed on Aug. 6, 2001.

(51) Int. Cl. B62D 55/02

(52) U.S. Cl. 180/9.36

(57) ABSTRACT

A vehicle comprising a frame assembly supported for movement by a centrally located driving track assembly and a pair of flanking driving and steering wheels. An engine is assembly carried by the frame assembly which is constructed and arranged to generate and supply power for the vehicle. The driving track assembly includes a track frame structure forming a part of the frame assembly, a series of rollers carried by the track frame structure including a driver roller and an endless track trained about the rollers so as to provide an operative ground engaging flight extending in a straight vehicle driving direction. A power operated track moving structure is operatively connected to the driver roller using power supplied from said engine assembly to move said track in driving relation to the ground. A wheel mounting assembly is provided for each wheel including wheel mounting structure constructed and arranged to mount an associated wheel for rotational movement about a generally transversely horizontally extending rotational axis and a parallel linkage mechanism operatively connected with the frame assembly extending laterally outwardly in connected relation to the wheel mounting structure constructed and arranged to enable the wheel mounting structure to be vertically moved in such a way as to effect a vertical translational movement of the rotational axis. A power operated wheel driving structure is operatively connected with each wheel and uses power supplied by the engine assembly to rotate an associated wheel about the rotational axis thereof. A power operated retractable and extendible unit is operatively connected between the track frame structure and each wheel which is constructed and arranged to effect a relative vertical movement of an associated wheel with respect to the track frame structure between retracted and extended positions.

### FIELD OF THE INVENTION

The present invention is generally related to vehicles and more particularly related to a vehicle for use on a wide range of terrain, including uneven and/or steep terrain having a variety of soil conditions. The vehicle of the present invention offers many advantages over conventional vehicles and can replace conventional vehicles in performing a variety of tasks.

### BACKGROUND OF THE INVENTION

Most conventional vehicles such as agricultural tractors, front end loaders and bulldozers are either driven by four wheels or by a pair of laterally spaced. parallel tracks. Four-wheeled vehicles have a pair of laterally spaced front wheels and a pair of laterally spaced rear wheels that engage the ground and rotate during vehicle movement. Typically one or both pairs of wheels are driven to move the vehicle. The wheels of the wheel-driven vehicles are generally large and have tread designs that aid in moving the vehicle over sand, clay and mud. Although capable of moving over terrain having a variety of soil conditions conventional wheel-driven vehicles frequently become stuck because all of the tractional forces and driving surfaces of the wheels are not always put to the ground. Typical track-driven vehicles employ steel or rubber endless tracks that are driven to move the vehicle over the ground.

Conventional four wheel vehicles and conventional two track vehicles often cause environmental damage when used in natural areas. Recently, environmental concerns have been raised about the disruption of the topsoil which occurs when conventional loader/bulldozer-type vehicles are operated on the topsoil, sand or other soft terrain of sensitive natural areas. For example, in the tree harvesting industry, construction industry and/or the agricultural industry, the operation of conventional vehicles of the type described may cause significant damage to the topsoil, which in turn may result in the formation of ruts which may lead to soil erosion.

It is self evident from the above that the advantage of a two-track tractor vehicle over a four-wheeled tractor vehicle is its traction and stability. On the other hand, the advantage of a four-wheel tractor vehicle over a two-track vehicle is in its ease of handling and maneuverability.

To a considerable extent, the tractor vehicle of my U.S. Pat. No. 5,615,748 patent achieves the advantages of both two track and four wheeled tractor vehicles. This is because it provides a central track for traction and stability and two outrigger wheel for ease of handling and maneuverability.

The outrigger wheels of my '748 tractor vehicle were steerable about a generally upright steering axis. The wheels were controlled using a steering mechanism capable of turning both wheels generally in unison about their respective steering axes to effect turning movement.

In my U.S. Pat. No. 6,044,921, it is disclosed that enhanced ease of handling and maneuverability can be achieved by utilizing outrigger wheels which are steered by changing the relative driving speed between the two outrigger wheels rather than by moving them in unison about upright steering axes. Further enhancement can be obtained by mounting the outrigger wheels for vertical movement and utilizing hydraulic cylinders and a control system therefor to maintain the wheels in ground contact.

The '748 or the '921 tractor vehicle, enhanced as aforesaid because it includes a central track and two outrigger wheels, is uniquely set up to enable a substantial portion of the load support to be shifted between the central track and the outrigger wheels. For example, if the hydraulic cylinders which keep the outrigger wheels in ground contact are adjusted so that a substantially low-pressure condition exists, the central track will support most of the vehicle load on the ground. As the pressure conditions in the hydraulic cylinders are increased, more and more of the vehicle load will be assumed by the outrigger wheels.

This substantial shift in load support occurs without any shifting of the load itself or any tilting of the frame. In contrast, the only way load support can be shifted between the two tracks of a two-track tractor or the four wheels of a four-wheel tractor is to shift the load itself. This unique load support shifting capability made possible by the use of hydraulic cylinders to keep the independently driving outrigger wheels on opposite sides of the central track in ground contact, enables traction and stability to be enhanced while at the same time further enhancing the ease of handling and maneuverability of the tractor vehicle.

Since existing two track tractors and four wheeled tractors do not have this load shifting capability, once they become stuck or bogged down in sloppy ground, there is nothing that can be done by the tractor itself to extricate itself from its mired condition. Shifting of the load carried between the central track and the outrigger wheels of the present vehicle allows the vehicle itself to vary the mired condition sufficiently to extricate itself from any one mired condition.

It has been found that further enhanced ease of handling and maneuverability can be attained by utilizing the steering signal to cause the outrigger wheels to assume more of the load support during a steering operation. For example, in some applications of the vehicle it has been found that it is advantageous when a steering input signal exceeds a predetermined steering signal level to increase the pressure within both suspension cylinders, thereby reducing the load on the track and allowing the vehicle to turn without excessive ground disturbance. In other applications of the tractor vehicle, it has been found that improved handling and maneuverability can be attained by utilizing the steering direction (and optionally the degree of the steering input) indicated by the steering input signal to cause the outer wheel in the turning direction to assume more of the load support than the inner wheel in the turning direction.

### BRIEF SUMMARY OF THE INVENTION

There is a need to make improvements in the functions of the disclosed vehicle or the way in which the existing functions are achieved in order to make the vehicle more commercially acceptable and cost effective.

It is the object of the present invention to make such improvements and thus fulfill the need expressed above. In accordance with the principles of the present invention this objective is obtained with respect to one improvement by providing

### SUMMARY OF THE INVENTION

A vehicle comprising a frame assembly supported for movement by a centrally located driving track assembly and a pair of flanking driving and steering wheels. An engine is assembly carried by the frame assembly which is constructed and arranged to generate and supply power for the vehicle. The driving track assembly includes a track frame structure forming a part of the frame assembly, a series of rollers carried by the track frame structure including a driver roller and an endless track trained about the rollers so as to provide an operative ground engaging flight extending in a straight vehicle driving direction. A power operated track moving structure is operatively connected to the driver roller using power supplied from said engine assembly to move said track in driving relation to the ground. A wheel mounting assembly is provided for each wheel including wheel mounting structure constructed and arranged to mount an associated wheel for rotational movement about a generally transversely horizontally extending rotational axis and a parallel linkage mechanism operatively connected with the frame assembly extending laterally outwardly in connected relation to the wheel mounting structure constructed and arranged to enable the wheel mounting structure to be vertically moved in such a way as to effect a vertical translational movement of the rotational axis. A power operated wheel driving structure is operatively connected with each wheel and uses power supplied by the engine assembly to rotate an associated wheel about the rotational axis thereof. A power operated retractable and extendible unit is operatively connected between the track frame structure and each wheel which is constructed and arranged to effect a relative vertical movement of an associated wheel with respect to the track frame structure between retracted and extended positions.

A manually operated speed determining mechanism is carried by the frame assembly which is constructed and arranged to be moved manually between a dead position wherein the track assembly and wheels are not moved and speed positions wherein the track assembly and the wheels are caused to be moved. A manually operated steering and signal generating mechanism is carried by the frame assembly which is constructed and arranged to be manually moved between a straight position wherein a straight steering signal is generated and the wheels are caused to move the vehicle in a straight direction, and opposite turning positions wherein turning steering signals are generated and the wheels are caused to turn the vehicle in a selected direction at a selected angle.

An electronic controller is operable to receive the steering signals generated by the steering and signal generating mechanism and to responsively control the power supplied from the engine assembly to the retractable and extensible units to move said wheels between said rectracted and extensible units and effect a load shift between the wheels and the track assembly so that (1) when a straight steering signal is received the wheels are moved into a retracted position wherein the wheels and the entire operative flight of the endless track are in ground engagement and share the load to provide maximum traction and (2) when a turning steering signal is received the wheels are moved into an extended position wherein the wheels and only a portion of the operative flight of the endless track are in ground engagement to facilitate turning movement.

### BRIEF DESCRIPTION OF THE DRAWINGS

FIG. 1 is a perspective view of a vehicle constructed according to the principles of the present invention;

FIGS. 2 and 3 are partially exploded views of a main frame and a portion of a drive track assembly of the vehicle;

FIG. 4 is a view showing the assembled main frame and driving track assembly with a track portion of the track assembly broken away and not shown and showing portion of a secondary driving assembly of the vehicle in partially exploded view;

FIGS. 5-9 are views showing various degrees of assembly of the vehicle;

FIG. 5 is a side elevational view of the main frame;

FIG. 6 is a view similar to FIG. 5 except showing the drive track assembly and a pair of counterbalance members mounted on the main frame;

FIG. 7 is a view similar to FIG. 6 except further showing a secondary driving assembly mounted on the vehicle with a wheel portion of the secondary driving assembly indicated by a dashed line;

FIG. 8 is a view similar to FIG. 7 except showing the opposite side of the vehicle and showing an engine assembly mounted on the vehicle with the secondary driving assembly not shown to more clearly show the engine assembly;

FIG. 9 is a side elevational view of the assembled vehicle showing a cab assembly mounted on the vehicle;

FIG. 10 is a schematic view of an example hydraulic system for the vehicle;

FIG. 11 is a schematic view of an example electronic control system for the vehicle; and

FIGS. 12-13 show flowcharts illustrate an example of the logic of certain vehicle control operations performed by the electronic control system of the vehicle.

### DETAILED DESCRIPTION OF THE PREFERRED EMBODIMENT OF THE INVENTION

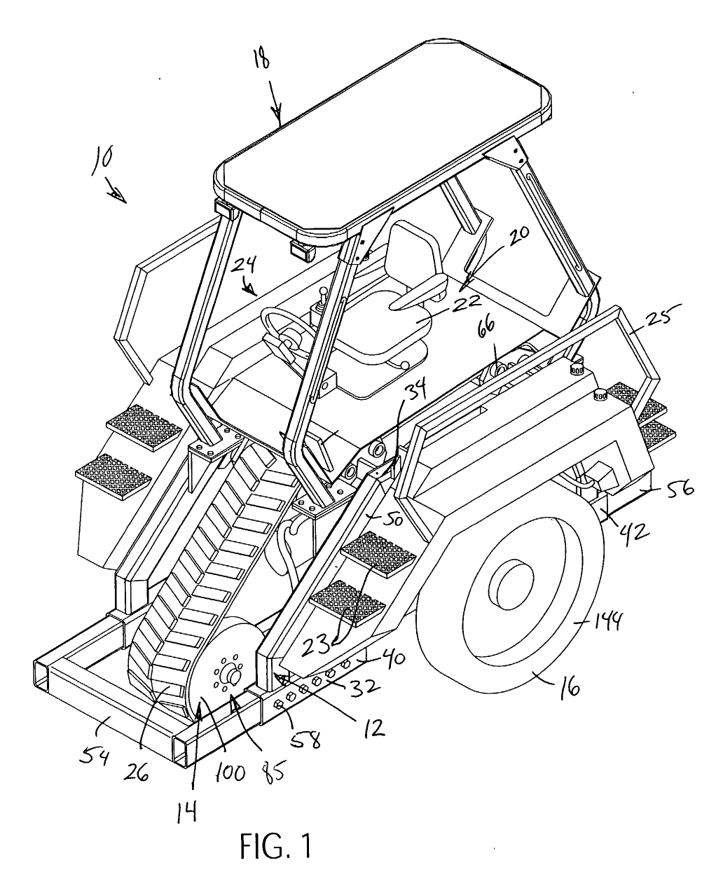

FIG. 1 is a left side perspective view (where the left and right directions are considered from the point of view of a forwardly facing vehicle operator) of a vehicle, generally indicated at 10, constructed in accordance with the principles of the present invention. The vehicle 10 is of the same general type as is disclosed in my U.S. Pat. Nos. 5,615,748 and 6,144,921, the entirety of each patent being incorporated into the present application in its entirety for all material disclosed therein.

The vehicle 10 includes a main frame, generally indicated at 12, a driving track assembly, generally indicated at 14, mounted to the frame 12, and a pair of secondary driving assemblies, each generally indicated at 16, disposed on opposing lateral sides of the track assembly 14 in flanking relation therewith. A cab assembly 18 is mounted on top of the main frame 12 and includes an operator cockpit 20. The cockpit 20 includes an adjustable operator's seat assembly 22 and a plurality of controls generally designated 24 which are used to operate and maneuver the vehicle 10 and to operate any implements (not shown) mounted on the front or rear (or both) of the vehicle 10. The cab assembly 18 provides an operator envelope in the cockpit 20 area that is ASAE/OSHA/MSHAW compliant and certified for rollover protection and for falling object protection. A plurality of steps 23 and a pair hand rails 25 are provided to assist the operator when entering and exiting the cab assembly 18. Preferably the seat portion of the seat assembly 22 is mounted on a seat suspension assembly (not visible in the figures) that functions to cushion the driver from “bumps” during vehicle movement, particularly on uneven terrain.

As explained below, the track assembly 14 includes a longitudinally extending, ground-engaging endless track 26, a hydraulically powered track motor, a fixed ratio track planetary gear assembly, a series of track-supporting idler rollers and a power driven track drive roller. The track motor drives the track drive roller which rotates the track 26 to move the vehicle 10 along the ground.

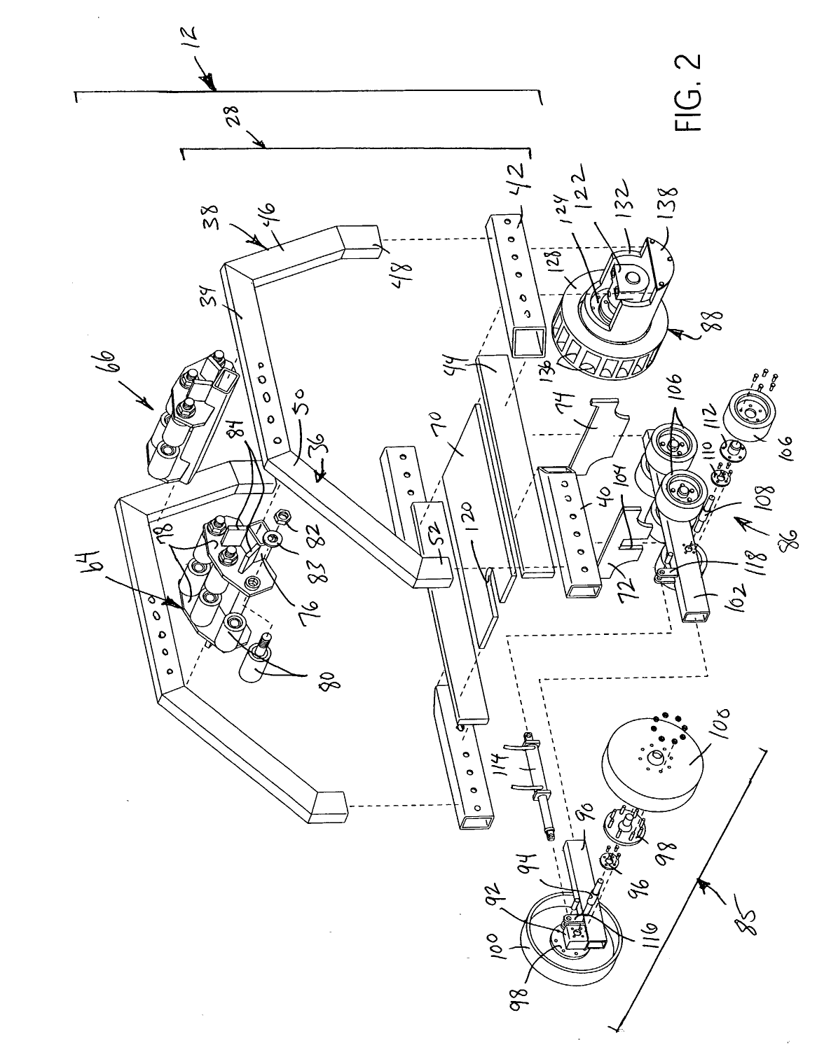

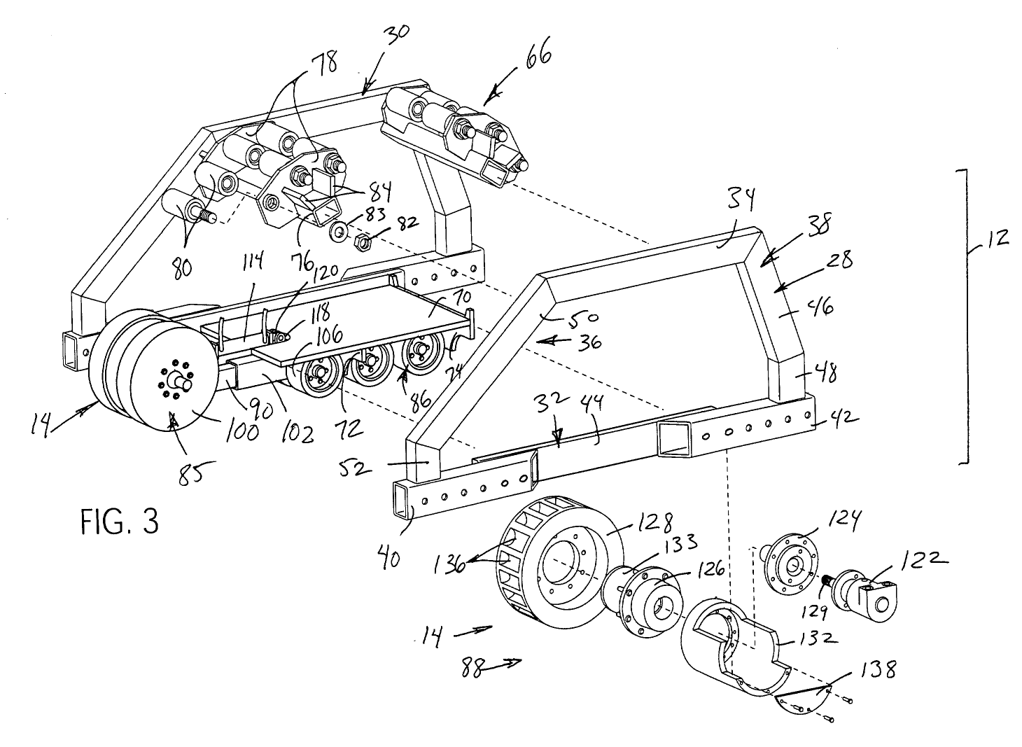

The construction of the frame 12 and the track assembly 14 can be best understood from FIGS. 2-4. The frame 12 is constructed of metallic components that are fixed together by welding or the like. The frame 12 is shown in partially exploded view in FIGS. 2 and 3. The frame 12 can be viewed as including a pair of frame side structures 28, 30. The side structures 28, 30 are of mirror image construction so only structure 28 is considered in detail, but the discussion applies equally to structure 30.

The side structure 28 (shown in partially exploded view in FIG. 2 and assembled in FIG. 3) includes a lower frame rail 32 (see FIG. 3), an upper frame rail 34, a forward frame rail 36 (see FIG. 3) and a rearward frame rail 38 (see FIG. 3). The lower frame rail 32 includes a pair of tubular sleeves 40, 42 and a central connecting member 44 rigidly secured therebetween. The rearward frame rail 38 includes tubular metallic upper and lower rearward frame members 46, 48. The forward frame rail 36 includes tubular metallic upper and lower forward frame members 50, 52. The upper frame rail 34 is a single integral tubular member. The members 34, 46, 48, 50, 52 can be welded to form an inverted generally U-shaped tubular structure that is in turn welded to the lower frame rail 32.

The vehicle includes forward and rearward counterbalance structures 54, 56, each of which is an elongated, generally U-shaped metallic tubular structure. Each counterbalance structure is telescopically received within associated pairs of tubular sleeves 40 or 42, respectively, for longitudinal movement with respect to the frame 12 and is releasably held in an adjusted position by locking bolts 58. Details of the construction, mounting, function and operation of the counterbalance structures 54, 56 is disclosed in the above-incorporated '451 patent application reference and will not be considered in further detail.

The frame 12 further includes a forward upper roller support assembly 64, a rearward upper roller support assembly 66, an engine assembly support structure 70 and a pair of laterally extending lower connecting structures 72, 74.

The structure of the forward and rearward upper roller supports 64, 66 is identical, so the structure of only the forward support 64 is considered in detail. The forward roller support 64 includes a main tubular structure 76 and a pair of laterally spaced, vertically extending roller support elements 78 rigidly affixed thereto. Three pairs of track-supporting upper idler rollers 80 are mounted on each roller support 64, 66 generally between the support elements 78 with nuts 82 and washers 83. The pairs of rollers 80 generally support the track 26 for rotational movement of the track 26 with respect to the frame. A pair of metallic auxiliary elements 84 are each affixed to the main tubular structure 76 at each end thereof and to an outwardly facing surface of the adjacent support elements 78 by welding or the like.

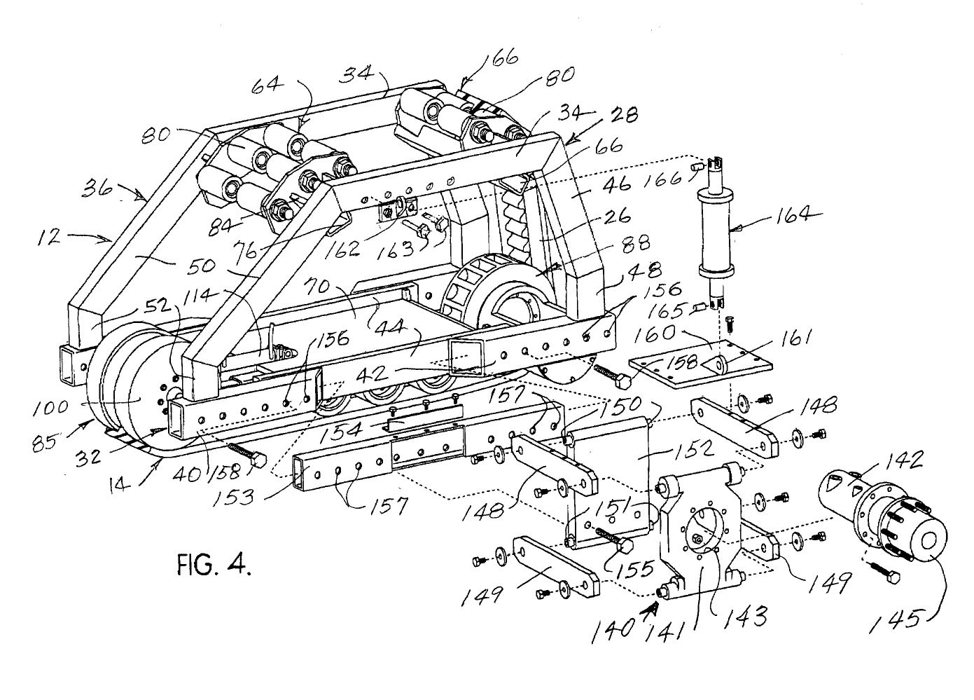

The upper roller supports 64, 66, the tubular support structure 68, the engine assembly support structure 70, and the pair of laterally extending connecting structures 72, 74 are metallic structures and, as best appreciated from FIGS. 3 and 4, are rigidly secured between the side structures 28, 30 (by welding or the like) to hold the longitudinally extending side structures 28, 30 in laterally space fixed relation.

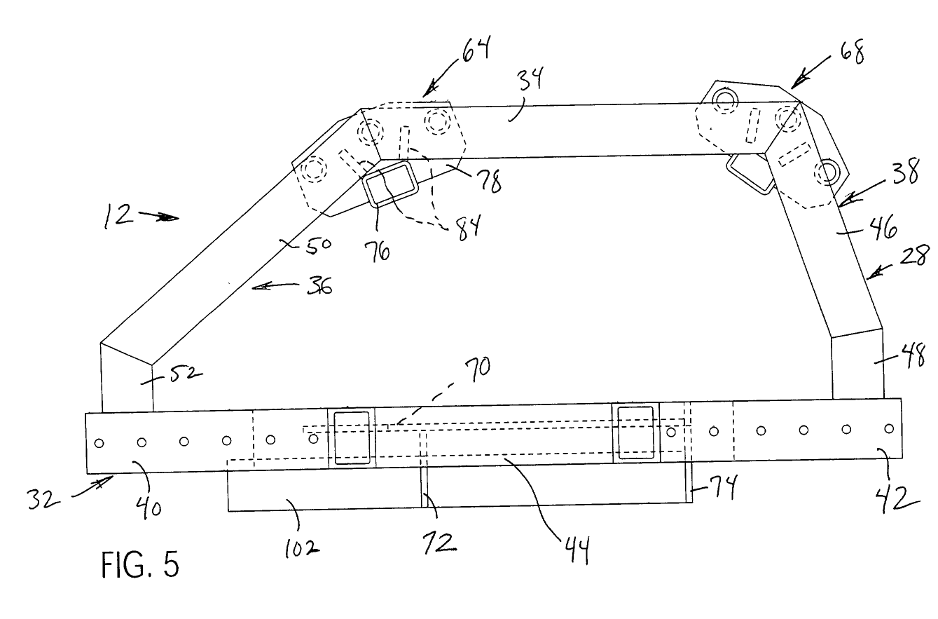

More particularly, each auxiliary element 84 is a plate-like structure. An outer edge surface of each auxiliary element 84 of each upper roller support 64, 66 is welded to an adjacent portion of the associated side structures 28, 30 (as can be understood, for example, FIG. 5).

The engine assembly support structure 70 is welded between the central connecting structures 44 of the side structures 28, 30 and provides a horizontally extending support surface for the engine assembly. The lower connecting structures 72, 74 are welded between the central connecting structures 44 of the side structures 28, 30 and are also welded to a bottom surface portion and a rearward edge portion, respectively, of the engine assembly support structure 70 to help reinforce the support structure 70 and to provide structure for mounting a portion of the track assembly 14, as will become apparent.

The track assembly 14 includes the track 26, the upper idler rollers 80, a front idler wheel assembly 85, a road wheel assembly 86, and a track driving assembly 88.

The front idler assembly 85 is shown in partially exploded view in FIG. 2. The front idler assembly 85 includes a tubular front wheel support 90 and a front axle support 92 adjustably mounted thereto. A front idler axle 94 is held within the axle support 92 by a pair of front axle retainer rings 96. A front idler bearing 98 is mounted on each end of the idler axle 94. A front idler wheel 100 is mounted on each bearing 98 for free rotational movement with respect to the axle 94. As considered in further detail below, the two front idler wheels 100 are held in laterally spaced relation to one another by the axle 94 to allow a plurality of teeth 134 integrally formed around the inside of the track 26 to pass between the spaced wheels 100 (as best understood from FIG. 4). It is contemplated to use a track 26 on the vehicle that is constructed of rubber. All rubber tracks are shaped somewhat differently from one another. A front adjuster assembly (not shown) is included in the front idler assembly 85 which allows the pair of front idler wheels 100 (and the associated structures including the axle support 92, the axle 94, the rings 96 and the bearings 98) to be shimmed right or left as a unit to ensure proper tracking of the track 26, particularly when the track 26 is a rubber track. “Shimming” thus refers to the movement wheels 100 laterally (bi-directionally from an imaginary longitudinally extending center line of the vehicle) with respect to a rear drive wheel 128 of the vehicle.

A tubular road wheel housing 102 is rigidly fixed below the engine assembly support structure 70 by welding or the like. The tubular housing 102 is affixed within a downwardly opening notch 104 in the connecting structure 72 and is welded to a forwardly facing surface of the connecting structure 74. Three pairs of idler road wheels 106 are rotatably mounted on the housing 102 by axles 108 (see FIG. 2). Each axle 108 is mounted on the housing 102 by a pair of retainer rings 110. An idler bearing 112 is mounted on each end of each axle 108 to rotatably mount a wheel 106 on each end of each axle 108.

The front wheel support 90 of the front idler wheel assembly 85 is telescopically received within a forward portion of the housing 102 and a track tensioning hydraulic piston assembly 114 is mounted between a bracket 116 on the front wheel support and a bracket 118 on an upper portion of the housing 102. FIG. 3 shows the assembled front idler wheel assembly 85 telescopically interengaged with the assembled road wheel assembly 86. A notch 120 is formed in the engine assembly support structure 70 to accommodate the piston assembly 114. The front idler wheels 100 are capable of movement in the longitudinal direction with respect to the road wheel assembly 86 and track driving assembly 88 in response to expansion and contraction of the hydraulic piston assembly 114 to tension the track 26.

The construction of the track driving assembly 88 is best understood from the partially exploded view of FIG. 3. The track driving assembly 88 includes a power-operated track operating motor 122, a support assembly 124, a track planetary gear assembly 126 and a track-engaging drive wheel 128. The support assembly 124, the track operating motor 122 and the gear assembly 126 are bolted together and to a track housing 132 such that a splined shaft 129 on the track operating motor 122 is in gear-meshing engagement with gears inside the planetary gear assembly 126. The operating motor 122 is mounted within a track housing 132 and the planetary gear assembly 126 is mounted on the exterior of the track housing 132. The track drive wheel 128 is bolted to a hub assembly portion 133 of the planetary gear assembly 126 and is operatively associated with the track operating motor 122 such that rotation of the motor shaft 129 rotates the track drive wheel 128 to drive the track 26 with respect to the frame 12. Preferably, the planetary gear assembly 126 is a fixed ratio device and is provided by a readily commercially available unit such as a Model 9 Wheel Drive commercially available from Scott Industrial Systems as part number Auburn 9WC114349B5Z. Preferably the planetary gear assembly 126 includes a spring-applied, pressure released brake mechanism.

It can be understood from FIGS. 2-4 that the assembled track driving assembly 88 is secured to the lower frame rail 32 of the side structure 28 by bolts in operative relation to the track 26. A removable cover 138 is bolted on the housing 132.

The track 26 is shown in fragmentary view in FIG. 4 mounted for rotational movement about the two rearward most pairs of upper idler rollers 80, lower portions of the front idler wheels 100 of the front idler wheel assembly 85 and the road wheels 106 of the road wheel assembly 86. FIG. 4 also shows the track 26 drivably engaged with the track drive wheel 128 of the track driving assembly 88. It can be appreciated from FIG. 4 that the track 26 is a rubber structure and includes the plurality of spaced teeth 134 which drivingly engage circumferentially spaced grooves or recesses 136 on the drive wheel 128. Preferably the track is manufactured by Goodyear Tire & Rubber and has the commercial part number 26400160XEXFX 26022. The upper idler rollers 80, the front idler wheels 100 and the road wheels 106 are laterally spaced to accommodate passage of the teeth 134 during rotation of the track 26. The teeth/grooves arrangement of the track assembly is an example of a positive drive configuration (also referred to as a sprocket-type drive). As an alternative to the example positive lug drive configuration, it is contemplated to replace the positive lug drive with a friction drive, that is, an arrangement in which the drive wheel frictionally engages and drives the track.

A secondary driving and steering assembly 16 is mounted on each side of the vehicle 10. A secondary driving and steering assembly 16 is shown in exploded relation to the frame 12 in FIG. 4. The secondary driving assemblies are of mirror image construction so only one assembly 16 is shown in FIG. 4 and is discussed in detail, but the discussion applies to both assemblies. The driving assembly 16 includes a vertically movable mounting structure, generally indicated at 140 including vertically movable part 141, a power-operated driving structure operating hydraulic motor 142, and a ground engaging driving structure preferably in the form of a ground engaging rotatable wheel 144 (shown, for example, in FIG. 1 but not shown in FIG. 4 to more clearly illustrate portions of the driving assembly 16). Alternatively, the ground engaging driving structure may be a small track assembly as shown in the above-incorporated '921 patent reference.

The vertically movable mounting structure 140, as shown, is preferably in the form of a laterally oriented parallel linkage assembly which is mounted on the frame 12 for longitudinal adjustment into a selected one of a plurality of fixed operative portions spaced longitudinally with respect to the frame 12.

As shown, the vertically movable part of the vertically movable mounting structure 140 is in the form of a generally vertically extending plate 141 having a central aperture 143 formed therein for reviewing the motor 142. As shown, hydraulic motor 142 is fixed to plate 141 by annular series of bolts 144. The hydraulic motor 142 includes a gear reduction rotor 145 which forms a nut to which ground engaging wheel 144 is detachably fixedly mounted in conventional fashion.

The plate 141 has journaled in the upper and lower end portions thereof upper and lower shafts 146 and 147 respectively. Opposite ends of the upper and lower shafts 146 are pivotally connected to outer ends of laterally extending upper and lower links 148 and 149 respectively. The laterally inwardly oriented ends of the upper and lower links 148 and 149 are, in turn, pivoted on opposite ends of upper and lower shafts 150 and 151 journaled on upper and lower end portions respectively of a fixed vertically extending plate 152. Plate 152 is suitably fixed to the central portion of an adjustable mounting member 153 in the form of a box beam of a size to telescopically move within the tubular sleeves 40 and 42 of the associated side structure 28. As can be appreciated from FIG. 4, an angle iron 154 is welded (in the assembled vehicle) to the back of the fixed plate 152 which is positioned (in the assembled vehicle) so that it extends over the central portion of the mounting member 153. Final securement is accomplished by bolts 155 which extend through the plate 152 and angle iron 154 into the mounting member 153.

Prior to accomplishing the securement of the plate 152 to the mounting member 153, the mounting member 153 is telescoped within the tubular sleeves 40 and 42 so that opposite end portions of the mounting member 153 are contained within the tubular sleeves 40 and 42 and the central portion thereof is exposed therebetween so that plate 142 can be secured thereto as aforesaid. It will be noted that mounting member 153 is formed with a series of longitudinally spaced openings 156 which can be made to selectively register with bolt reviewing openings 157 in the tubular sleeves 40 and 42. Bolts 158 can then be used to fixedly secure the mounting member in its selected position of longitudinally adjustment.

As best shown in FIG. 2, the longitudinally spaced pair of transversely extending links 148 are fixedly interconnected by a plate 160 bolted to the pair of links 148. Plate 160 has a lower pivot element 161 fixed thereon which extends laterally outwardly. An upper pivot element 162 is provided which is fixedly mounted on the frame 12 in a selected position of longitudinal adjustment, as by bolts 163, corresponding with the selected position of adjustment of the parallel linkage assembly 140.

The lower and upper pivot elements 161 and 162 function to mount a power-operated mounting structure mover in the form of an extensible and retractable hydraulic piston and cylinder suspension assembly, generally indicated at 164, in operatively connected relation between the frame 12 and wheel 16. As best shown in FIG. 2, the lower operative connection includes a lower pivot pin 165 between the lower end of the hydraulic piston and cylinder assembly 164 and the lower pivot element 161 and the upper operative connection includes an upper pivot pin 166 between the upper end of the hydraulic piston and cylinder assembly 164 and the upper pivot element 162.

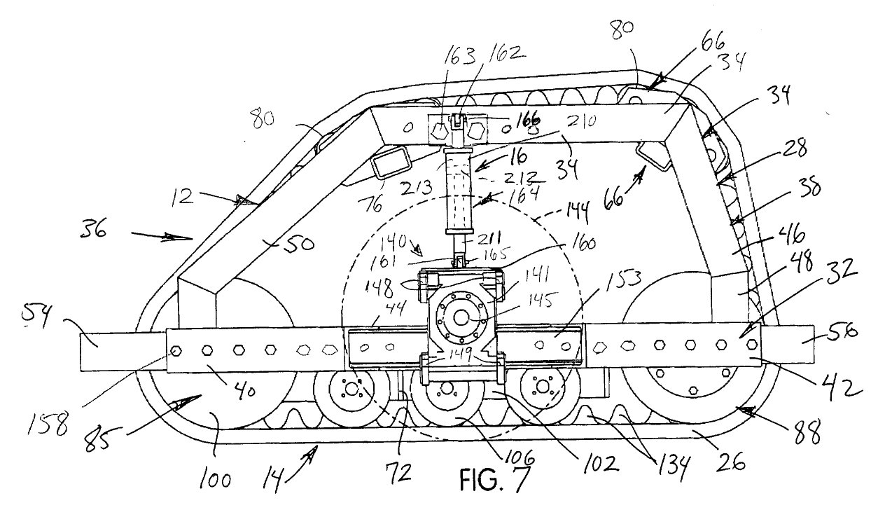

As mentioned, each secondary driving assembly 16 further includes a power-operated mounting structure mover in the form of an extendible and retractable hydraulic piston and cylinder suspension assembly 164 (see FIG. 7, for example) that is in fluid pump system as described below. The suspension assembly 164 is constructed and arranged to move the plate generally vertically with respect to the mounting member 153 so as to maintain a bottom surface of the associated wheel 16 in generally parallel relation to the ground to assure optimal engagement of the treaded outer surface of each tire with the ground surface in all vertical positions of the plate 141. Preferably the tire mounted on each wheel 16 is a biased tire.

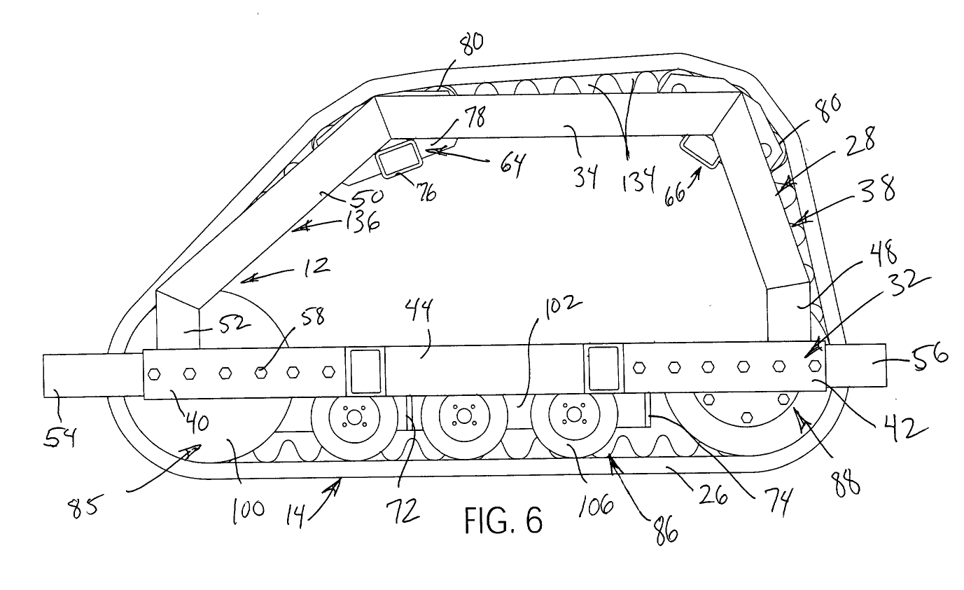

FIGS. 5-9 show various stages of assembly of the vehicle 10 in side elevational view. FIG. 5 shows a side elevational view of the frame 12. FIG. 6 shows the track assembly 14 mounted on the mainframe 12. FIG. 7 shows suspension assembly 164 with each parallel linkage assembly 140 mounted between the frame 12 and a wheel 144 of the secondary driving assembly 16 indicated with dotted lines. The forward and rearward counterbalance structures 54, 56 are shown mounted on the frame 12 in FIGS. 6-9.

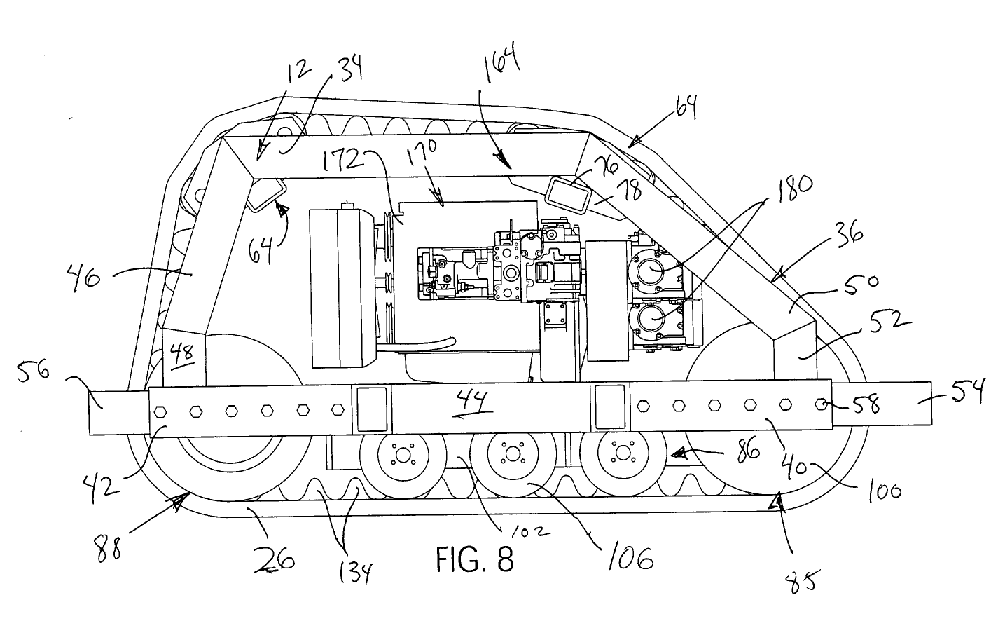

As best seen in FIG. 8, an engine assembly 170 is mounted to the frame within the track envelope. The engine assembly 170 (and the associated hydraulic and control assemblies) is preferably as described below, but it is contemplated to use the engine assembly arrangement (and the associated hydraulic and control assemblies) disclosed in either the above-incorporated '921 patent or in the above-incorporated '748 patent.

The engine assembly 170 generally includes an internal combustion (IC) engine 172, a gear box transfer case 174 mounted to the internal combustion engine, and four hydraulic pumps mounted on the gear box 174. Preferably, the internal combustion engine 172 is a model TMD T27 Continental 80 horsepower diesel engine commercially available from Wisconsin Total Power Corporation of Memphis, Tenn. and the gear box 174 is model number P.O. GB-S1 commercially available from Superior Gearbox Co., P.O. Box 645, Stockton, Mo.

The diesel engine drives the four pumps. The IC engine 172, the gear box 174 and the four hydraulic pumps are shown in side elevational view in FIG. 8. The four pumps include: 1) a track drive pump 178, 2) a pair of a wheel drive pumps 180a, 180b and 3) and an implement pump 182. The gear box is bolted to the IC engine 172 and is operatively coupled to the engine 172 through a flex plate that drives the main gear in the gear box 174. Each pump 178, 180, 182 is bolted to the gear box 174 and is operatively connected to the gear box 174 through a splined coupling. There is a 1:1 gear ratio between all of the pumps 178, 180, 182 and the gear box 174.

It can be appreciated from FIG. 8 that one wheel pump 180a is mounted to the gear box 174 in line with the shaft of the engine 172 and that the other wheel pump 180b, the track pump 178 and the implement pump 182 are mounted in line with one another and generally parallel to the motor shaft of the engine 172. Both wheel pumps 180a, 180b and the track pump 178 are mounted directly to the gear box 174 and the implement pump 182 is “piggybacked” on the track pump 178.

Preferably the track pump 178 is a Sunstrand series 90 axial piston closed loop pump commercially available from the Sauer-Sunstrand Co. of Ames, Iowa, the wheel pumps 180 are Sunstrand series 42 axial piston closed loop pumps also commercially available from the Sauer-Sunstrand Co. and the implement pump 182 is a series 45 axial piston open circuit pump commercially available from the Sauer-Sunstrand Co.

The track pump 178 is fluidly communicated to the track operating motor 122 by a pair of hydraulic lines. Preferably the track operating motor 122 is a Model SE 90 Track Motor is commercially available from Sauer-Sunstrand Co. Each wheel pump 180 is fluidly communicated to a respective wheel motor 142 by a pair of hydraulic lines (not shown). Preferably each wheel operating motor 142 is a Model MMF-35 wheel drive motor commercially available from the Sauer-Sunstrand Co. In one preferred embodiment of the vehicle 10, each wheel pump and each track pump is a variable displacement pump and each associated motor is a variable displacement motor.

The implement pump 182 is operable to control any implements (not shown) mounted on the front or rear (or both) of the vehicle 10, to supply hydraulic oil to the piston assembly 114 to tension the track 26 and to operate the suspension assemblies 164 associated with the secondary driving assemblies 16 to control the suspension system in a manner described below.

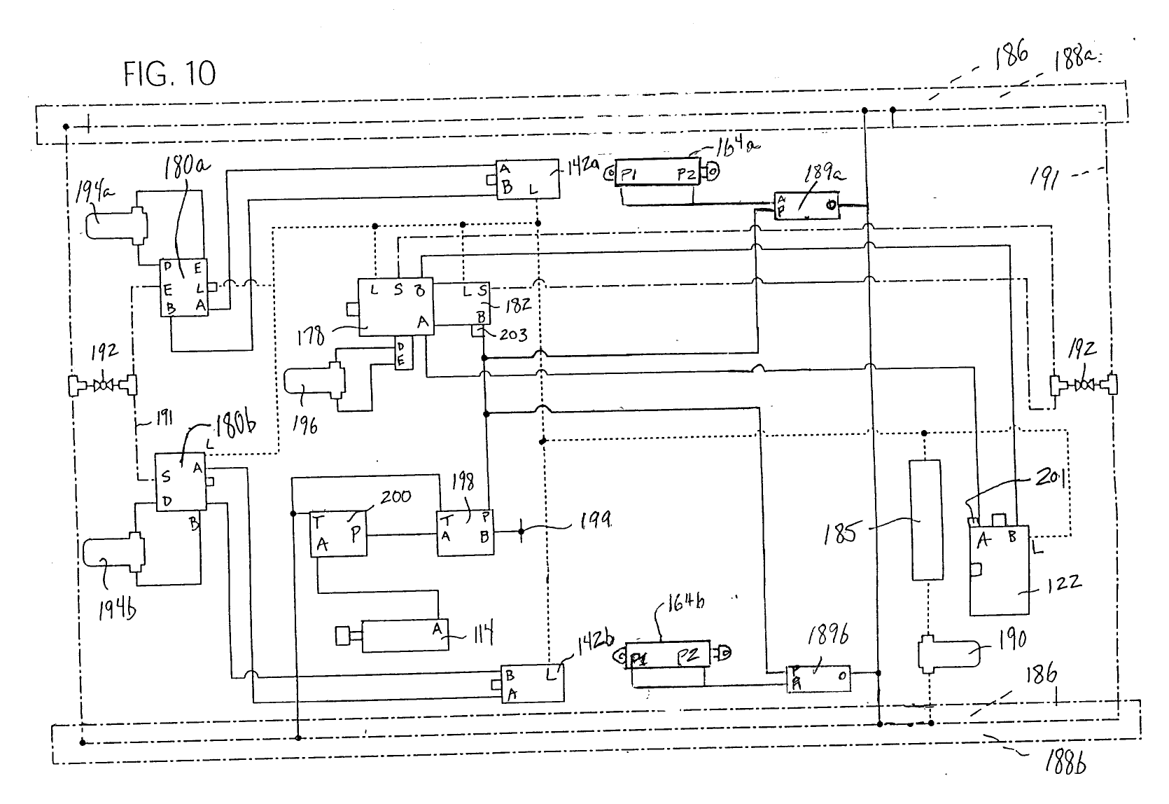

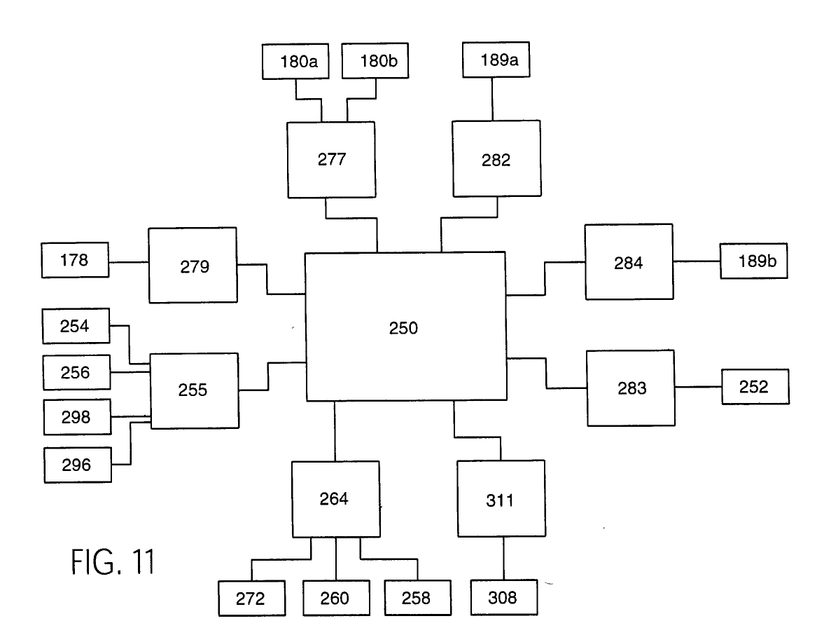

To tension the track 26, the pump 182 acts through a pair of track tensioning valves (shown in schematic view in FIG. 10 and designated 198 and 200). One or both track tensioning valves 198, 200 are manually adjustable to set a predetermined base pressure that corresponds to the track tension desired. If an object of sufficient size gets between the track 26 and a wheel 80, 100, 106 or 128, the hydraulic pressure in the track tensioning cylinder 114 rises sufficiently above the base pressure to release fluid from the piston assembly 114, thereby allowing the track tensioning cylinder 114 to contract and the object to disengage from the track assembly 14. As soon as the object is out of the track assembly 14, the track tensioning cylinder 114 will expand until its internal pressure goes back to the predetermined base pressure level.

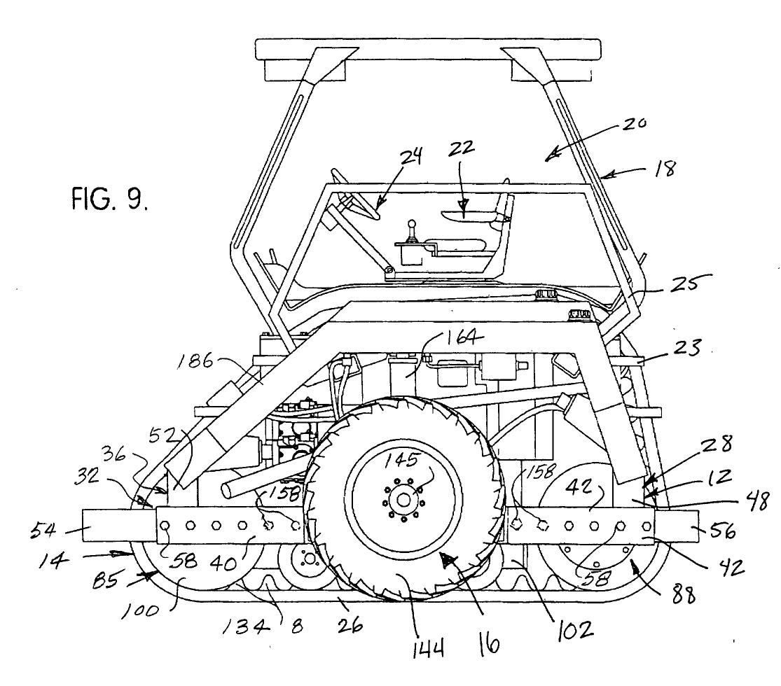

The engine 172 is mounted to the engine assembly support structure 70 of the main frame 12 by isolator and conical mounts (not shown). A radiator 184 and a hydraulic oil cooler 185 (shown, for example, in FIG. 8) are mounted within the envelope of the track 26 in fixed relation to the engine assembly support structure 70. As best seen in FIGS. 1 and 9, a tank assembly 186 is mounted on each side of the main frame 12. Each tank assembly 186 is made from welded rectangular tubing and has an inverted “U” shape. Each tank assembly 186 includes two separate compartments, one compartment being for hydraulic oil and the other compartment being for fuel oil. The two tank assemblies 186 together provide the example vehicle 10 with a 60 gallon capacity for hydraulic oil (i.e.. 30 gallons on each side) and a 30 gallon capacity for fuel oil (15 gallons on each side) which will run the vehicle 10 for approximately 12 hours.

Because of the high total hydraulic oil capacity provided by the two tank assemblies 186 relative to the number and size of the pumps 178, 180, 182 driven by the engine assembly 170, and because of the inverted U-shaped configuration of each tank assembly 186 (and therefore of each chamber within each tank assembly 186) which provides a high degree of surface area as compared to a single rectangular-shaped tank, the temperature of the hydraulic oil is not raised sufficiently by the heat generated during vehicle operation to require the hydraulic oil cooler 185 in many applications. Thus, the hydraulic oil cooler 185 is optional.

Each hydraulic oil-containing chamber in each tank assembly 186 includes at least three suction ports. A suction port is provided at or near the lowermost end of each leg portion of each inverted U-shaped chamber and in approximately the center of the bight portion of each chamber. The diesel fuel-containing chambers of the two tank assemblies 186 have a similar three port configuration. Corresponding suction ports on the pair of hydraulic oil chambers are connected together and to the suction side of each of the three pumps 178, 180, 182 through “T”-type connectors. Similarly, corresponding fuel ports on the pair of fuel oil chambers are connected together and to the fuel intake on the diesel engine 172 through “T”-type connectors. Because of the inverted U-shape of the fuel and oil chambers and because of the positioning of the paired tank assemblies 186 on each side of the engine assembly 170, and because the tank assemblies 186 on opposite sides of the vehicle are fluidly connected through “T” connectors, this assures that the engine 172 will receive diesel fuel and that all hydraulic pumps 178, 180, 182 will receive hydraulic oil regardless of the orientation of the vehicle 10 and regardless of the level of fuel or hydraulic oil in the tank assemblies 186.

As will become apparent, the hydraulic oil chambers act as a reservoir which supplies oil to the suction side of each hydraulic pump 178, 180, 182. The track pump 178 and each wheel pump 180 is fluidly communicated to an associated hydraulic motor 122, 142 and sends high pressure oil thereto. Hydraulic oil tank pressure is typically approximately 6-7 pounds. Each pump 178, 180 182 and each motor 122, 142 also has a case drain. Case drain pressure refers to a relieving of oil pressure inside each pump and inside each motor to protect the pumps and the motors from damage due to excessive fluid pressure. Each case drain from each pump and each motor returns oil to the tank assemblies 186.

An example hydraulic schematic of a preferred hydraulic system for the vehicle 10 is shown in FIG. 10. Another example hydraulic system (including hydraulic schematics) suitable for use with the vehicle 10 of the present invention is shown and described in my '921 patent reference incorporated in its entirety above.

The two hydraulic oil compartments of the two tank assemblies 186 are shown in dashed lines in FIG. 10 and are designated 188a and 188b to indicate that these compartments are identical but are mounted on opposite sides of the frame 12. In the discussion of the vehicle 10 in general and of the hydraulic schematic in particular, identical components are indicated with identical reference numbers and distinguished from one another by the use of lowercase letters following the reference number. The hydraulic schematic shows the three driving pumps (i.e., the track pump 178 and the wheel pumps 180a, 180b) and shows the implement pump 182. Each hydraulic oil compartment 188a, 188b functions as a reservoir for the hydraulic system.

Generally, hydraulic oil flows through the suction lines 191 (indicated by broken lines) coming out of each of the tank compartments 188a and 188b and flows into the suction port “S” of each pump 178, 180a, 180b, 182. Each drive pump 178, 180a, 180b has a pair of outlet ports A and B that are fluidly communicated to inlet ports A and B on the associated drive motors 122, 142a, 142b. The B port on the implement pump 182 is connected to the pressure feed port P on control valve 198. The A port on the control valve 198 is fluid communicated to the pressure feed port P on the control valve 200. The B port on the control valve 198 is fluid communicated to an auxiliary valve 199 mounted on the exterior of the vehicle 10. The auxiliary valve 199 is provided for hydraulically powering implements mounted on the vehicle. The A port on the control valve 200 is fluid communicated to the track tensioning cylinder 114 to tension the track 26.

The B port on the implement pump 182 is also in fluid communication to an input port (a “P” port) on each of a pair of pressure compensated reducing valves 189a, 189b. An A port on each pressure compensated reducing valve 189a, 189b is in controlled fluid communication with an associated suspension assembly 164a, 164b, respectively, (through ports P1 and P2 on each suspension assembly 164) to control fluid flow into and out of the associated assembly 164. An oil output port O on each pressure compensated reducing valve 189a, 189b is fluid communicated with both tanks 188a, 188b through “T” connectors to allow hydraulic fluid leaving the pressure compensated reducing valve 189a, 189b to return to the tanks.

Each pump 178, 180a, 180b, 182 and each motor 122, 142a, 142b has a case drain port “L” that drains through the oil cooler 185 (optionally) and then through an oil filter 190 and back to the compartments 188a, 188b. A ball valve 192 is connected between suction lines on each side of the schematic. An oil filter 194a, 194b is associated with each pump 180a, 180b and an oil filter 196 is connected to the pumps 178, 182.

The spring applied, pressure released brake 201 (shown schematically in FIG. 10 as a block operatively associated with the track motor 122) is mounted in the track planetary gear assembly and is operatively connected with the hydraulic pump 182. The brake 201 is applied to lock the drive wheel 128 when hydraulic pressure drops below a predetermined level to prevent rotation of the drive wheel 128 and thereby prevent the vehicle 10 from moving. The brake is released from breaking engagement with the drive wheel 128 by application of a predetermined level of hydraulic pressure which is normally in the line. A 12 volt on/off solenoid valve 203 is tied into the pump circuit for pump 182 as shown in FIG. 10 and is operable to either set or release the brake 201 when the engine 172 is running. An on/off switch that controls the on/off solenoid valve 203 to set and release the brake 201 is mounted in the vehicle cockpit 20, preferably on a side of an FNR (forward/neutral/reverse control mechanism, as explained below) speed control lever mounted in the cockpit.

The pair of control valves 198, 200 are operatively connected between the pump 182 and the track tensioner cylinder 114. Preferably the control valve 198 is a FV-4544 control valve and preferably the control valve 200 is a FV-4553 control valve.

One skilled in the art will appreciate that the hydraulic system shown in FIG. 10 eliminates the use of directional valves because the three track and wheel pumps 178, 180a, 180b, respectively, can provide fluid flow in two directions by reversing the direction of operation of a swash plate (not shown) within each pump and thereby change the direction of fluid flow to each motor (i.e., into either the A or B port). By changing the direction of fluid flow, each motor 122, 142a, 142b can be run in forward or reverse directions to, for example, run the track and wheels in forward or reverse directions or to counter rotate the wheels.

The mounting of a suspension assembly 164 can be appreciated from FIG. 7. A mounting structure 171 on the piston side of the cylinder 167 is pivotally connected to the bracket 162 attached to the frame 12. The rod 173 of the suspension assembly 164 is pivotally connected at 161 to the plate 160.

Vehicle Control System

Propulsion of the vehicle in forward and reverse directions is accomplished by driving the track 26 and the wheels 144. The track 26 provides the main driving power. The wheels 144 help laterally stabilize the vehicle 10 and wheel rotation imparts force to the vehicle 10 to supplement the main driving power of the track assembly 14. The wheels 144 also steer the vehicle 10. During a steering operation, the wheels 144 can be operated to assume a greater portion of the vehicle load to reduce track 26 ground pressure. Steering is accomplished by differential rotation of the wheels 144. More specifically, differential speed steering is accomplished by reducing the travel rate of one wheel while keeping the other wheel speed constant. In other words, both of the wheels and the track are driven at equal travel rates during linear (i.e, “straight” vehicle movement in the forward or reverse directions) vehicle movement and steering is accomplished by simply reducing the travel rate of one or the other wheel (depending upon the direction in which the vehicle is to be turned) while keeping the opposite wheel and the track traveling at their pre-turn rates. The vehicle 10 turns in the direction of the wheel traveling at the relatively slower travel rate. It is also contemplated to turn the vehicle by counter-rotating the wheels 144 (in a manner described below) while the track 26 is driven at its pre-turn speed (i.e., rate of travel).

Generally, differential wheel speed steers the vehicle 10 because the relative amount of force imparted to the vehicle 10 by each ground engaging wheel 144 during differential rotation is unequal and these unequal forces act to turn the vehicle 10. The hydraulic assemblies 164 of the secondary driving assemblies 16 utilize pressurized fluid supplied from the hydraulic pumps of the engine assembly and are operable to vertically move the wheels 144 with respect to the track assembly 14 and thereby control the amount of pressure applied by each wheel 144 to the ground. By vertically moving the wheels 144, it can be ensured that all of the vehicle's 10 tractive forces are applied to the ground, even when driving over uneven terrain.

Various operator controls are provided in the cockpit 20 to control the vehicle 10. Generally, input signals from the various controls are electrically communicated to a programmable electronic controller (as “inputs” to the electronic controller). The electronic controller, in response to these inputs, is operable to control various operations of the vehicle including, for example, the vertical position and rotational speed and direction of the wheels 144 (to effect, for example, wheel differential speed or wheel counter rotation), the rotational speed and direction of the track 26 and hydraulic pressure in each suspension assembly 164. Hydraulically powered implements (not shown) mounted on the vehicle 10 may be operator controlled (that is, controlled by the operator manipulating a manually operated hydraulic control device without involving the electronic controller), although various degrees of computerized control of implements are contemplated.

The example vehicle 10 weighs approximately 11,000 pounds (without implements), has a lateral track 26 width of 16 inches and has an outside-to-outside lateral distance between the wheels 144 of approximately 80 inches. The diesel engine is 80 horsepower. The components of the vehicle 10 can be used with an internal combustion engine 172 that is up to 175 horsepower. The size, weight, and power of the vehicle 10 makes the vehicle useful for a wide range of applications.

Each pump 178, 180, 182 may be an axial piston variable displacement pump of cradle swash plate design. Each pump 178, 180, 182 converts an input torque from the internal combustion engine 172 into hydraulic power. The high pressure fluid is then ported out either the A port or the B port of the associated pump 178, 180 or 182 to provide power to the associated motors 122, 144.

The swash plate angle can be varied by a control piston. Changing the swash plate angle varies the displacement of fluid per revolution of the input shaft of the pump. A larger angle causes greater displacement which yields greater output torque for the given input. A smaller angle reduces the displacement per revolution and yields greater speed for a given input. The swash plate can be angularly adjusted to achieve this variable fluid flow outwardly from either the A or the B port. Thus, the swash plate can be angularly adjusted to adjust the volume, pressure and direction of hydraulic fluid flow out of pump 178, 180, 182. Either the A line or the B line can be pressurized to make the associated motor 122 or 142 go forward or in reverse.

Each hydraulic motor 122, 142 converts an input hydraulic power into an output torque. The output torque from the motor 122, 142 rotates the associated flanking wheel 144 or track wheel 128. Each pump 178, 180 and each motor 122, 142 may be a variable displacement device. Alternatively, each pump 178, 180 may be a variable displacement device and each associated motor 122, 142 may be a fixed displacement device or, alternatively, a two-speed device.

When a pump 178, 180 or 182 is idle, it is referred to as being “de-stroked”. Each pump 178, 180, 182 is normally de-stroked. Each pump 178, 180, 182 includes an electric displacement control (EDC) that causes tilting of the swash plate in response to an electrical input signal, thus varying the pump's displacement from full displacement in one direction through a neutral (i.e., idle) swash plate position to full displacement in the opposite direction. The electrical input signal can be, for example, a DC voltage or a current. The electrical input control signal to a particular pump 178, 180, 182 is generated by a suitably programmed and properly interfaced electronic controller. As explained in greater detail below, the electronic controller generates a pump input signal in response to an input signal the controller receives from an input device controlled by the vehicle operator. In response to the pump input signal sent by the electronic controller, each EDC controls the direction, the flow and the pressure of the hydraulic fluid coming out of the associated hydraulic pump 178, 180, 182 and thereby controls motor speed, direction of travel, and so on.

The suspension assemblies 164 function to move the wheels 144 vertically with respect to the frame of the vehicle 10. The suspension assemblies 164 can be operated to move the wheels together or independently of one another. As explained in greater detail below, operation of the suspension assemblies 164 is, in the example embodiment of the vehicle, controlled in part by the electronic controller based on steering input data and position sensor data. The suspension assemblies 164 can also optionally be controlled directly by the vehicle operator using manual control switches in the cockpit.

Generally, the vehicle 10 is operated with a predetermined ground bearing or “baseline” pressure established in one or both suspension assemblies 164. The baseline pressure may be determined by the electronic controller or may be determined by the operator or by a combination of both. The suspension assemblies 164 are operable to ensure that the wheels 144 engage and follow the ground with a predetermined baseline pressure, even if the ground contour is uneven. More specifically, the pressure compensated reducing valves 189 operate to maintain the baseline operating pressure in both of the suspension assemblies 164 during vehicle operation (as explained below), thereby ensuring continuous ground engagement by both wheels 144 during vehicle movement.

The suspension assemblies 164 can also be operated to vary the portion of the vehicle weight borne by the wheels 144 relative to the track 26, particularly during vehicle turning operations. As discussed below, it is contemplated to electrically control each pressure compensated reducing valve 189 such that the hydraulic pressure of both suspension assemblies 164 (and thus the ground bearing pressure of the associated wheel) increases above the pre-turn baseline pressure level by an amount dependent on the magnitude (which magnitude depends on the degree of displacement of the steering wheel from its neutral or straight ahead position) of a steering input signal electrically communicated to the electronic controller. As previously indicated, each suspension assembly 164 preferably constitutes a retractable and extendible unit in the form of a conventional piston and cylinder unit including cylinder 210, piston rod 211 and piston 212 which forms in the cylinder a load bearing chamber 213 (see FIG. 7).

The piston and cylinder unit 164 can be single acting. Preferably, however, the piston and cylinder units 164 are double acting and hydraulically interconnected on opposite sides of the piston 212 so that movement can be achieved by displacing a volume of fluid equal to the piston and rod displacement.

The pressure compensated reducing valve 189 associated with each piston and cylinder unit 164 when directing fluid to flow to the unit, the fluid will flow into the load bearing chamber 213 of the unit 164 since this fluid is acting on a greater area of the piston 212 than the piston rod chamber, conversely, when fluid is allowed to flow from the unit 164 by the pressure compensated reducing valve 189, the flow will be from the load bearing chamber 213 for the same reason. This extends or retracts the unit 164 and thereby vertically raises or lowers the associated wheel 144 to decrease or increase, respectively, the portion of the load or weight of the vehicle 10 borne by that wheel, and therefore, also the proportion of the vehicle load or weight borne by the track 26. The hydraulic fluid flow into and out of each unit 164 is controlled by the associated pressure compensated reducing valve to assure that the baseline pressure is maintained in each of the unit 164 to provide, for example, ground-following action of the wheels 144 with respect to the ground surface during vehicle movement.

The electronic controller is programmed in the example embodiment to establish an initial or “default” baseline pressure (for example 650 pounds of hydraulic pressure) in each suspension assembly 164 when the vehicle is started. The baseline pressure can be changed by the operator to any value within a range of values during vehicle operation. The operator could change the baseline pressure for many reasons including in response to varying ground conditions (soil type, etc.) and weather conditions. Once a baseline is established in a suspension assembly 164, the pressure compensated reducing valves generally operate to maintain that pressure during, for example, straight ahead vehicle movement, thereby causing the wheels 144 to remain in driving engagement with the ground, even over rough terrain.

It can be appreciated that as the vehicle 10 moves along the ground, the ground contour causes the pressure in each load bearing chamber 213 to fluctuate. For example, if the vehicle 10 is moving forwardly along a ground surface and a wheel 144 encounters a depression in the ground, that wheel would be momentarily suspended over the depression. As a result, the fluid pressure in the associated load chamber 213 would decrease below baseline pressure. In the example system, the associated pressure compensated reducing valve 189 would operate to cause hydraulic fluid to flow into the associated cylinder to return the baseline pressure to the target value (650 pounds in this example). This in flow of hydraulic fluid would occur essentially instantaneously and cause the associated wheel to move into contact with the ground at the baseline pressure. Generally, the electronic controller commands each pressure compensated reducing valve 189 to establish a baseline pressure in the associated suspension assembly. Each valve 189, in response, continuously monitors the pressure in the associated suspension assembly and maintains the commanded baseline pressure therein until the electronic controller sends a new command signal.

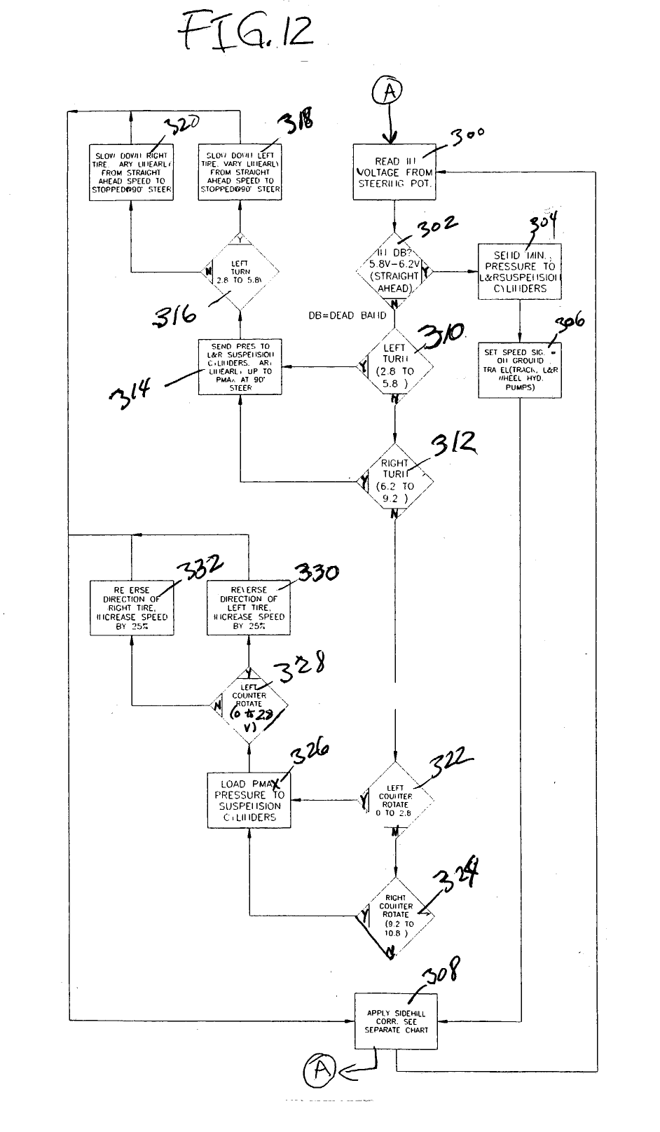

A schematic diagram of an example electronic control system for the vehicle 10 is shown in FIG. 12. FIG. 12 shows an electronic controller 250 with a plurality of devices electrically communicated to the controller 250. These devices include some of the operator-controlled input devices mounted in the cockpit 20 (for controlling the motor and wheel pumps 178, 180, for example) and various other devices (not mounted in the cockpit 20) communicated to the controller 250 including a pair of position transducers operable to indicate the vertical position of each wheel relative to the frame and track.

The operator-controlled input devices electrically communicated to the controller 250 include a speed signal input device 252 for inputting an operator selected forward or reverse vehicle speed. The speed signal input device 252 in the example embodiment is provide by a joystick-type descrete position “forward-neutral-reverse lever” (or “FNR lever”). The input speed signal is a digital signal that is sent from the input device 252 to the electronic controller 250 utilizing an interface 283. The electronic controller 250 receives a vehicle direction signals from the FNR lever 252.

A steering signal input device 254 for affecting differential speed or counter rotation of the flanking wheels 144 is electrically communicated to the electronic controller 250 utilizing interface 255. The steering signal input device 254 is a rotary potentiometer-type steering wheel, but could also be a joystick-type potentiometer or other suitable device.

Other operator-controlled input devices include an inchbrake 256 which is communicated to the electronic controller 250 utilizing interface 255. The inchbrake 256 shown is in the form of a foot pedal-type potentiometer electrically communicated to the controller 250 to progressively slow (or stop) the pumps 178, 180 in a manner described below to limit vehicle speed (or stop the vehicle).

An increase/decrease pressure setpoint switch 258 is mounted in the cockpit and is communicated to the electronic controller 250 through interface 264. The operation of switch 258 is described below. A “dozer mode” or control reversal switch 272 is mounted in the cockpit 20 and is electronically communicated to the electronic controller 250.

The electronic controller 250 also communicates with a plurality of output and feedback devices. The right and left wheel pumps 180a, 180b are communicated to the electronic controller 250 by interface 277. The track pump 178 is communicated to the electronic controller 250 by interface 279. The electronic controller 250 controls the right wheel pump 180a, the track pump 178 and the left wheel pump 180b by sending control signals to pump interfaces 277, 279, which, in response, communicate pump-controlling voltage signals to the respective pump EDC's.

The electronic controller 250 is communicated to the valves 189a, 189b utilizing interfaces 282, 284, respectively. The electronic controller 250 controls the operation of the right suspension cylinder valve 189a and the left suspension cylinder valve 189b by sending control signals to a valve controllers 282, 284, respectively.

The positions of the right and left suspension cylinders are electrically communicated to the electronic controller 250 by a right suspension position transducer 296 and a left suspension position transducer 298, respectively. The position transducers 296, 298 are electrically communicated to the electronic controller 250 utilizing interface 255. The position transducers 296, 298 provide feedback signals to the electronic controller 250 to enable the electronic controller 250 to determine the vertical position of each wheel of the vehicle relative to the frame and central track.

The electronic controller 250 is electrically communicated to an audible backup warning indicator 308 utilizing interface 311.

Vehicle Operation

The single track and two flanking wheel design of the vehicle 10 provides the advantages of both wheel- and track-driven vehicles and makes the vehicle 10 useful for a wide range of applications in a wide range of working environments. The electronic controller 250-assisted operation of the vehicle 10 simplifies vehicle operation from the point of view of the vehicle operator while increasing vehicle functionality and vehicle responsiveness to various working environments.

Generally, to operate the vehicle 10, the internal combustion engine 172 is started to power the pumps 178, 180, 182. The engine 172 operating speed can vary (based on operator input), but in normal operation the engine 172 will run at a predetermined high idle rate. For example, the engine 172 typically operates at 3,000 rpm.

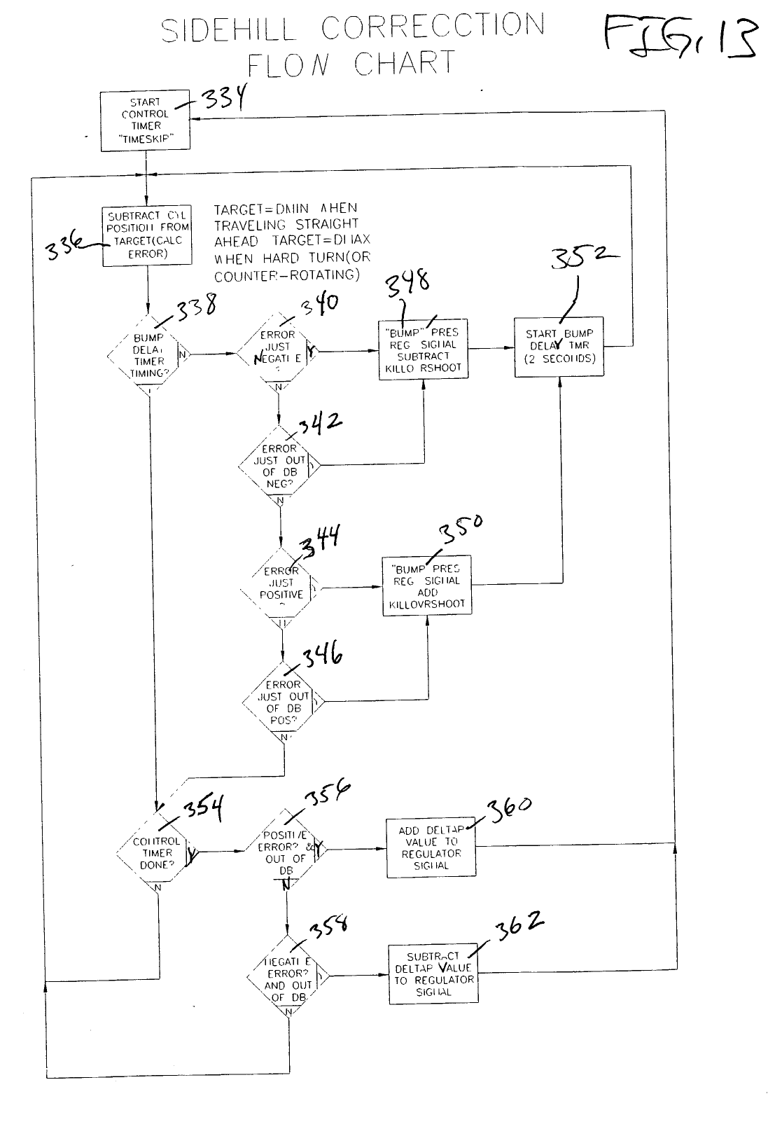

The electronic controller 250 is powered up and initialized when the vehicle 10 is started. The operation of the electronic controller 250 during vehicle 10 operation can be understood with reference to FIGS. 13 and 14. The FNR lever 252 is in neutral at start up and the electronic controller 250 is initialized to send each pump 178, 180 a zero voltage so that each pump is destroked at start up.

The electronic controller 250 determines the position of the FNR lever 252 measuring the voltage signal received from the FNR lever 252. More specifically, the FNR lever 252 receives a voltage signal from the vehicle battery and sends voltage signal to the electronic controller 250 as a speed control input. The example FNR lever 252 has six internal switches (not shown) that indicate the position the lever is in. More specifically, the first switch indicates when the lever 252 is in neutral, the second switch indicates when the FNR lever 252 is in forward, and the third switch indicates when the FNR lever 252 is in reverse. Three additional switches indicate which discrete speed-indicating position the lever is in. The example FNR lever 252 has six forward speed positions, a neutral position and six reverse speed positions.

The switches within the lever 252 cooperate to generate a digital signal that is transmitted to the electronic controller 250. The electronic controller 250 reads this input and generates appropriate output signals to command the pumps 178, 180 to drive the vehicle at a particular forward or reverse speed. That is, the electronic controller 250 in response generates appropriate output control signals to the interfaces 277, 279. The interfaces 277, 279 in response, send control voltages to the EDC's of the three pumps 178, 180 to drive the vehicle in the selected direction and speed.

When the FNR lever 252 is moved out of neutral in a forward (or reverse) speed direction, the pumps 178, 180a, 180b respond by commencing hydraulic fluid flow to the associated motors in a forward-motion (or reverse-motion) causing direction. This resulting fluid flow causes the track 26 and wheels 144 to begin rotation and to reach their commanded forward (or reverse) speeds in unison (assuming no steering input signal is commanded during this speed control operation). When the speed input device 252 is in its neutral position, the device 252 communicates to the controller 250 an appropriate input signal to cause the electronic controller 250 to de-stroke the wheel and track motor pumps 180, 178. Reverse motion of the vehicle 10 may be accomplished in the reverse manner.

In the example vehicle, of pump EDC's accept voltage inputs in the range of plus or minus 10 volts. When the controller sends a zero volts signal to each EDC, the associated pump is destroked. When the controller sends a +10 volt signal (or a −10 volt signal) to a pump EDC, the pump is driven at its full forward speed (over full reverse speed). Thus, the electronic controller 250 causes the electronic interfaces 277 to send an analog output signal that is within the range of +/−10 volts to the right and left drive pumps for the left and right wheels to control the speed of the left and right wheels, respectively. The electronic controller 250 controls the operation of the track pump in a similar manner. A positive voltage (sent to each pump 178, 180) moves the vehicle forward and a negative voltage (sent to each pump 178, 180) moves the vehicle in reverse.

When the lever 252 is in its first (forward) gear position, the controller 252 sends approximately a 3.7 volt signal to each wheel pump 178a, 178b. This drives each wheel at approximately 37 percent of its maximum speed in the forward direction. The electronic controller 250 is programmed to calculate the track pump speed 180 from the wheel speed by taking into account the differences in diameter of a flanking wheel and the track drive wheel and also taking into account the difference in fluid displacement of the wheel pumps and wheel motors as compared to the track pump and track motor. In the second, third, fourth, fifth and sixth gear positions, the vehicle is driven at approximately 47%, 58%, 70%, 86%, and 99%, respectively, of its maximum forward speed. The lever 252 operates in a similar manner in the reverse direction.

Steering of the example vehicle 10 is accomplished by shifting a greater portion of the weight of the vehicle from the track to the wheels (relative to the weight distribution of the vehicle between the track and wheel immediately prior to commencing the steering operation) and through differential speed rotation of the wheels 144. This weight shifting is helpful for several reasons, including that the weight shift increases the tractive engagement between ground and the wheels and that during a steering operation, the weight shift aids the track 26 in skidding laterally along the ground surface.

The steering wheel 254 receives an electrical signal from a DC to DC power supply (not shown) that is electrically communicated to the vehicle battery. The DC to DC power supply receives a voltage from the vehicle battery. During operation of the vehicle, the battery voltage typically varies within a range such as, for example, from 10 to 15 volts, depending on the operation of the alternator. The DC to DC power supply converts the battery voltage to AC (alternating current), transforms, rectifies and regulates the voltage so that the DC to DC outputs one or more essentially constant voltages such as, for example, 12 and 24 volt signals. The DC to DC power supply provides a constant reference voltage (or voltages) which can be used to communicate to the electronic controller 250 the position of various operator-controlled input devices including the steering wheel 254, the inchbrake, and the position sensors.

In the example vehicle, the steering wheel 254 potentiometer receives a 12 volt reference signal from the DC to DC power supply and outputs a voltage that is between 10% and 90% of the reference voltage so that the output voltage is between approximately 1.2 volts and 10.8 volts. When the steering wheel is in its neutral position (i.e., in its centered or “straight ahead” position), the steering wheel potentiometer outputs a 6 volts signal to the electronic controller 250.

Generally, the electronic controller 250, in response to receiving a left or right steering input signal from the steering input device 254 1) causes differential wheel rotation which turns the vehicle 10 and 2) increases suspension pressure to shift a portion of the vehicle weight from the track 26 to the wheels 144. During a turn, the speed of the “outside” wheel (i.e., the wheel on the opposite side from the turning direction) does not change (relative to its pre-turn speed), but the speed of the “inside” wheel (i.e., the wheel on the same side as the turning direction) decreases by an amount that is roughly proportional to the percentage the steering wheel is moved out of neutral in the steering direction through a predetermined portion of the range of movement of the steering device. In the example vehicle 10, the steering wheel is capable of moving 135° from neutral in each direction. The electronic controller 250 is programmed such that the wheel speed of the inside wheel decreases in direct proportion to the angular displacement of the steering wheel from neutral (zero degrees) through 90°. At 90°, the inside wheel has zero velocity and beyond 90 degrees, the wheels begins to counter rotate. During counter rotation, the inside wheel has a speed of 125% of its forward, pre-turn speed and rotates in the reverse direction. Thus, during counter rotation, the outside wheel rotates at 100 percent of its pre-turn speed in the forward direction and the inside wheel rotates at 125 percent of its forward speed in the reverse direction.

Thus, the track and outside wheel remain at their pre-turn forward speeds (which speeds are determined by the position of the FNR lever 252 and do not change during the steering operation unless the lever 252 is moved) during a turn. During counter rotation, the vehicle turns while remaining essentially in place. In the example vehicle, the electronic controller 250 is programmed such that counter rotation is only allowed when the FNR lever 252 is in its first, second and third speed positions. When the FNR lever 252 is in its fourth, fifth and sixth positions, the inside wheel speed decreases in direct proportion to the angular displacement of the steering wheel from neutral through 90 degrees. At ninety degrees the inside wheel speed is zero and remains zero through the rest of the range of motion of the steering wheel in the turning direction (i.e., 90 degrees through 135 degrees in the steering direction). The wheel speeds are changed by the action of the controller 250 causing voltages to be sent to the respective wheel pump EDC's that proportionally increase or decrease the pump outputs of the track and wheel pumps 178, 180.

The controller 250 is also programmed in the example vehicle to cause the hydraulic pressures in both suspension assemblies 164 to operate at a minimum pressure when the vehicle is moving straight ahead and to increase this minimum pressure during a steering operation by a percentage that is equal to the percentage of the movement of the steering wheel in a turning direction from neutral through a predetermined portion of its total range of movement in that particular steering direction. In the example vehicle, the electronic controller 250 adjusts the suspension pressure through a range from a minimum pressure (Pₘᵢₙ) to a maximum pressure (Pₘₐₓ). The pressure varies through this range directly proportionately to the angular amount the steering wheel is turned from neutral to 90 degrees. Thus, at zero degrees, the suspension pressure is a Pmin. At 90 degrees the suspension pressure is at Pₘₐₓ. Beyond 90 degrees through 135 degrees, the suspension pressure remains at Pₘₐₓ. As the steering wheel returns from its 90 degree position to neutral, the pressure decreases proportionately from Pmax to Pmin.

This increase of suspension assembly 164 pressure shifts a portion of the vehicle weight (i.e., ground bearing pressure) from the track 26 to the wheels 144, as mentioned above. When the steering wheel is returned to its neutral position, the controller 250 causes the suspension assembly 164 pressure to go back to the Pmin pressure level, thereby causing a portion of the vehicle weight to shift from the wheels 144 back to the track 26 (and causes the inside wheel 144 to return to its pre-turn speed, that is, to the forward speed determined by the position of the FNR lever 252).

Generally, during straight ahead (i.e., “non-turning”) forward or reverse movement, the suspension assemblies 164 are operated at Pmin. As the steering wheel of the example vehicle is turned from neutral through a predetermined portion of its range of motion (the predetermined range of motion being 0 to 90° out of the total 135° range of motion possible for the steering wheel of the example vehicle), the suspension pressure increases from Pmin to Pmax. The pressure increases from Pmin to Pmax in direction proportion to the amount the steering wheel is moved from 0 to 90 degrees. A typical baseline pressure range of the suspension assemblies 164 of the example vehicle 10 is from 600 psi (i.e., Pmin=600 pounds of pressure) to 1450 psi (i.e., Pmax=1450 pounds of pressure). The Pmin and Pmax values are initially set to these values by default when the vehicle is started. Pmin can be increased by the operator during operation of the vehicle if required by, for example, operating conditions as explained below. The electronic controller 250 causes a pressure change in the suspension assemblies 164 by commanding the pressure compensated reducing valves to assume a particular pressure. The pressure compensated reducing valves are operable to maintain the commanded pressure until these valves receive another command from the electronic controller 250 to change suspension assembly pressure. There is no pressure feedback signal sent from the suspension assemblies 164 back to the to electronic controller 250. The example vehicle 10 thus uses an open loop control system to control suspension assembly pressure.

As mentioned, the operator can adjust the minimum pressure in the suspension assemblies 164 as needed to adjust vehicle 10 operation to the particular terrain and ground conditions in which the vehicle is operating. When the ground is relatively hard and dry, for example, the minimum pressure can be set relatively low. If the ground surface is soft or slippery, minimum pressure can be increased to prevent the wheels 144 from slipping during a turn or during straight ahead vehicle movement. The pressure compensated reducing valves will then monitor and adjust the suspension assembly 164 pressure in the associated suspension assembly to maintain the newly established pressure.

The flowcharts of FIGS. 12 and 13 illustrate, respectively, the steering (or turning) logic performed by the electronic controller 250 and “hillside correction” logic (the purpose of which is explained below) performed by the electronic controller 250.

The electronic controller 250 reads the steering wheel 254 voltage at 300. The electronic controller 250 determines if the steering wheel voltage is between 5.8 volts and 6.2 volts at 302. This voltage range represents a “dead band” which the electronic controller 250 interprets to be a straight ahead command. This voltage dead band corresponds to an angular dead band of about +/−5 degrees from zero degrees (neutral) steering wheel displacement. This dead band prevents the steering wheel from being too sensitive. If the steering wheel is within the dead band, the electronic controller commands the pressure compensated reducing valves to establish minimum pressure in the left and right suspension cylinders at 304. The electronic controller sets the track speed equal to the wheel speed at 306. The electronic controller 250 executes the hillside correction logic flowchart (shown in FIG. 14 and described below) at 308. Following execution of 308, the program returns to 300.

If the steering wheel 254 output voltage is between 2.8 and 5.8 volts, the electronic controller 250 interprets this as a left turn at 310. This corresponds to a steering wheel displacement in the range of from just over 5 degrees to 90 degrees to the left. Similarly, if the steering wheel 254 output voltage is between 6.2 and 9.2 volts, the electronic controller 250 interprets this as a right turn at 312. This corresponds to a steering wheel displacement in the range of from just over 5 degrees to 90 degrees to the right. If the condition at either 310 or 312 is true, the electronic controller 250 commands the pressure compensated reducing valves at 314 to increase pressure in their associated suspension assemblies 164 above Pmin to a level directly proportional to the amount the steering wheel has been displaced between 5 and 90 degrees. There is, in other words, a linear relationship between steering wheel displacement and pressure increase and as the steering wheel 254 is turned from 5 degrees to 90 degrees (in either steering direction), the pressure increases linearly from Pmin to Pmax.

The electronic controller checks began to determine if the steering wheel is steering to the right or left at 316. If the steering wheel is turned to the left, the electronic controller 250 slows down the left wheel at 318. The electronic controller slows the left wheel linearly in direct proportion to the amount the steering wheel is displaced between 5 and 90 degrees to the left. As mentioned above, the left wheel is fully stopped when the steering wheel is at the 90 degree left position. Similarly, if the steering wheel is turned to the right, the electronic controller 250 slows down the right wheel at 320. The electronic controller slows the right wheel linearly in direct proportion to the amount the steering wheel displaced between 5 and 90 degrees to the right. The right wheel is fully stopped when the steering wheel is at the 90 degree right position.

The electronic controller determines if the steering wheel is turned beyond 90 degrees to the left or right at 322 and 324, respectively. If the steering wheel voltage is between the zero and 2.8 volts, the electronic controller determines that the steering wheel is between 135 degrees (corresponding to the zero volts) and 90 degrees (corresponding to 2.8 volts) to the left. Similarly, if the steering wheel voltage is between 9.2 and 10.8 volts, the electronic controller determines that the steering wheel is between 135 degrees (corresponding to 10.8 volts) and 90 degrees (corresponding to 9.2 volts) to the right. When the steering wheel is turned beyond 90 degrees to the right or the left, the electronic controller commands the pressure compensated reducing valves to raise the suspension pressure in each suspension assembly to Pmax at 326.

The electronic controller 250 determines if the steering wheel is over 90 degrees to the left at 328. If this is true, the electronic controller commands the pump associated with the left wheel to drive the left wheel at 125% of the forward speed indicated by the FNR lever 252 in the reverse direction (assuming the FNR lever 252 is in first, second or third gear position) at 330. In the condition at 328 is not true, the electronic controller 250 commands the pump associated with the right wheel to drive the right wheel at 125% of the forward speed indicated by the FNR lever 252 in the reverse direction (assuming the FNR lever 252 is in first, second or third gear position) at 332.

As stated above, when the vehicle 10 is in fourth, fifth and sixth FNR lever 252 positions, the counter rotation of the wheels does not occur. Thus, in these higher speed settings, the inside wheel speed decreases linearly as the steering wheel 254 is turned from 5 to 90 degrees, reaching zero velocity at 90 degrees. The inside wheel speed remains at the zero velocity even with continued movement of the steering wheel beyond its 90 degree position (right or left).

The hillside correction flowchart is executed at 308. The hillside correction flowchart is shown in FIG. 13. Essentially, the hillside correction logic utilizes position feedback information from the position sensors on the wheels to determine if correcting logic needs to be applied to the underlying basic logic of FIG. 13. A position feedback sensor is mounted on the cylinder of each suspension assembly and is operable to measure the vertical position of the associated wheel. Each position transducer in the example vehicle 10 is a linear voltage displacement transducer and generates a feedback voltage that the electronic controller uses to determine the length of the transducer and therefore of the associated suspension assembly.

The electronic controller 250 uses the feedback information from the position transducers to laterally stabilize the vehicle by keeping the suspension assemblies approximately equal length. An example will illustrate why the hillside correction logic is needed. If the vehicle is driven across the slope of a hillside, the downhill wheel bears a greater proportion of the weight of the vehicle. The pressure compensated reducing valves on each cylinder are operable to maintain the commanded pressure in each cylinder. The electronic controller commands a suspension assembly pressure based on steering wheel position as described above. Consequently when the vehicle is on a hillside the pressure on the downhill side suspension assembly increases and the pressure on the uphill side suspension assembly decreases. Has a result, the pressure compensated reducing valves operate to take oil out of the downhill side suspension assembly and to cause oil to go into the uphill side suspension assembly. This causes the downhill side suspension assembly to shorten and the uphill side suspension assembly to lengthen, thereby causing the vehicle to tilt or lien in the downhill direction. It is desirable to control the vehicle so that the suspension assemblies remain equal length, even when the vehicle is traveling across the gradient of a hillside. The electronic controller is programmed to use the position feedback signals from the perspective position sensors to stabilize the vehicle in a side hill and similar situations.

The logic described in the hillside correction flowchart of FIG. 13 is operable to add or subtract a correction signal to the basic suspension assembly pressure control logic of FIG. 13 to keep a suspension assemblies equal length at all times. Consequently, when the vehicle is traveling across a flat surface, the frame is laterally level and when the vehicle is traveling across the gradient of the slope, the vehicle is angled to a degree determined by the angle of the slope. In other words, the hillside correction logic of FIG. 13 is not operable to laterally level the frame of the vehicle on a hillside with respect to vertical. This mode of operation allows the lateral extent of the track to remain fully in contact with the ground surface at all times, even when going across the gradient of a hillside.

The logic of the hillside correction chart of FIG. 13 is applied independently to the left and right suspension cylinders. The discussion of FIG. 13 will be carried out with respect to the right suspension assembly, but it can be understood that it is contemplated to execute the program for the left suspension assembly in the same manner as for the right.

The hillside correction logic begins at 334 where the electronic controller 250 starts a timer called “timeskip”. The timeskip timer times for a period of one half second in the example flowchart of FIG. 13.

The electronic controller 250 determines the length error of each suspension cylinder by subtracting the actual position of the cylinder (and therefore of the associated wheel) from the target position, so that

ΔL=L_{T}−L_{A}

where ΔL is the length error, L_{T} is the target position or length and L_{A} is the actual portion or length. The electronic controller 250 determines the target position for each suspension assembly from the steering wheel position. More specifically, when the steering wheel is at a particular angular position, each suspension assembly should have a particular pressure. When the suspension assemblies operate at a particular pressure, they should have a particular known length associated with that pressure.

In the example vehicle 10, each suspension assembly has a range of motion of about 5 inches total. At Pmin, each suspension assembly has expanded to the 1 inch position. At Pmax, each suspension assembly has expanded to the four inch position. Thus, normal steering operations cause each suspension assembly to move through a three inch range. The additional inch on either side of this range provides enough additional lengthening and contracting movement of the suspension assemblies to allow “ground following” movement of the wheels (explained below). There is a positional dead band at each target length throughout the range of motion of each suspension assembling of approximately +/−½ (one half) inch that plays a role in the logic of the side hill correction flowchart, as explained below. Thus, when a suspension assembly has a target length of “X” inches, the dead band is in the range of X inches +/−½ (one half) inch.

The electronic controller 250 determines whether a “bump delay” timer is timing at 338. The bump delay timer (which is explained below) times for a period of two seconds in the example vehicle 10. If the bump delay timer is not timing (meaning that the right suspension assembly has not been “bumped” in the last two seconds), then the electronic controller determines if the value of ΔL has just become negative (i.e., changed sign from positive since the last “scan” or execution of the flowchart of FIG. 13) since the last calculation of ΔL at 340. If this is true and if the right suspension assembly is still within its dead band, the electronic controller 250 “bumps” the pressure of the right suspension assembly at 348, meaning that the electronic controller 250 changes the voltage level of the pressure compensated reducing valve regulating the pressure of the right suspension assembly by a relatively great amount (relative to a voltage corresponding to a ΔP adjustment described below) to increase or decrease (as appropriate) the suspension pressure of the right suspension assembly by a relatively high amount.

Thus, a “bump” refers to the act of causing a relatively high pressure change (either a pressure increase or decrease, depending upon whether the right suspension assembly is getting shorter than or longer than its target length) in the associated suspension assembly. The reason that a bump is initially needed to correct the length of the suspension assembly is because, as a general rule, it takes more force to start movement in a suspension assembly that is initially at rest than it does to keep a suspension assembly that is in motion moving in its direction of motion. Similarly, when a position correcting bump has been applied to a suspension assembly to initiate movement of the suspension assembly back towards its equilibrium position (i.e., ΔL=0), a second “kill overshoot” bump is needed to stop the motion of the suspension assembly when it moves beyond the equilibrium point. A bump is needed to initiate motion of a suspension assembly because when a suspension assembly is at rest, there is a certain amount of resistance to movement due to static friction and this static frictional force has to be overcome before movement will begin. The bump is just large enough to overcome static friction or slightly less. Motion of a moving hydraulic suspension assembly needs to overcome dynamic friction but does not need to overcome static friction. Dynamic friction is typically much lower than static friction. On the example of vehicle, when the electronic controller 250 bumps a suspension assembly, it changes the pressure (determined during execution of the flowchart of FIG. 13) by about 300 pounds of pressure. This corresponds to a voltage change to the associated pressure compensated reducing valve of about 1 volt.

Thus, if the error ΔL has just changed sense at 340 (by going from positive to negative), the electronic controller 250 bumps the right suspension assembly back towards the equilibrium position. Thus, bumping the suspension assembly pressure when the error has just gone from position to negative results in making a step decrease in the voltage sent to the associated pressure compensated reducing valve and consequently in the suspension pressure of the associated cylinder. Thus, a negative error means that the suspension assembly is extended too far because the actual suspension assembly length is greater than the target length.) The electronic controller then starts the bump delay timer at 352.

If ΔL is detected at 342 as being just out of the dead band (where “just” means that it was detected as being within the dead band during the last scan or the last time this condition was checked) and where ΔL is negative, then the electronic controller bumps the right suspension assembly at 348 and starts the bump delay timer at 352 as previously described.

The program performs an analysis and takes actions similar to those described for 340, 342 and 348 at 344, 346 and 350, respectively, for errors occurring in the positive direction. After bumping the suspension assembly at 350, the electronic controller starts the bump delay timer at 352.

If the right suspension assembly has been bumped at either 348 or 350, then the bump delay timer is started at 352 and control passes back to 336 where ΔL is calculated again. If the bump delayed timer is timing at 338, the electronic controller 250 determines at 354 whether the timeskip is still timing or if its one half second period has expired. Is the skip timer is still timing, the electronic controller 250 calculates ΔL again at 336. If the skiptimer is expired, the electronic controller determines at 356 whether the error is both positive and out of the dead band. If it is, the electronic controller 250 adds an approximately ⅛th volt voltage increase to the pressure compensated reducing valve of the right suspension assembly at 360. If the error is negative and out of the dead band at 358, the electronic controller 250 subtracts an approximately ⅛th of a volt voltage decrease from the pressure compensated reducing valve of the right suspension assembly at 362. A ⅛th volt change in the pressure compensated reducing valve voltage corresponds to approximately a 37.5 pound change in the suspension pressure in the example vehicle 10.

As a more specific example, if the target length, L_{T}, corresponds to a voltage of 5 volts and the position dead band corresponds to a voltage of +/−1 volt, then the right suspension assembly is within its dead band if the voltage reading is from 4 to 6 volts. If, however, the value of ΔL is calculated to be 5.1 volts at 340 and was calculated to be 4.9 volts the last time the flowchart of FIG. 14 was executed. Then error ΔL is determined to be just negative (because target length minus actual length calculated at 336 is 5.0 volts minus 5.1 volts which is negative) at 340. The electronic controller 250 has therefore determined that the error has changed sense (by going from positive to negative) even though it is still within the dead band) and therefore responds by bumping the pressure in a corrective direction at 348 to bring the right suspension assembly back toward its equilibrium position of L_{T}. The condition at 340 normally is not true unless the suspension assembly has been out of the dead band in the opposite direction is now passing over the equilibrium position as a result of an over correction. In this situation, the bump would tend to stop the corrective movement of the suspension assembly so that the suspension assembly is now at its equilibrium position.

The construction of the vehicle 10 allows the vehicle 10 to be driven with the operator facing in either of the two longitudinal vehicle directions. The vehicle seat is reversible to allow the driver to face in either longitudinal vehicle direction. Specifically, the seat can be unlatched from a latch or locked position facing in one longitudinal direction, swiveled 180 degrees and re-latch in a position facing in the opposite direction. The dozer mode switch is a two position toggle switch that is provided as an input to the controller 250 to indicate to the controller which direction the seat is facing in, and therefore, which of the two vehicle directions is the “forward” reference direction from the point of view of a driver sitting in the seat. When the driver wishes to drive facing in the opposite direction, the driver reverses the direction of the seat so that he faces in the opposite longitudinal direction and then changes the position of the control reversal switch 272 which reverses the effect of the (direction dependent) driver-operated input controls as described by way of example immediately below.

Preferably the steering wheel 254 (and other direction dependent controls including the FNR lever) swivel with the seat so they are always in front of the driver and in the same relative positions from the point of view of the driver regardless of which longitudinal direction the seat and driver are facing in. Based on which of its two positions the control reversal switch 272 is in, the electronic controller 250 is programmed such that the vehicle controls behave the same way from the operator's point of view regardless of the direction in which the driver is facing. Thus, for example, when the seat is facing in either longitudinal direction and the seated driver moves the FNR lever 252 “forward” (from the seated driver's point of view), the vehicle moves “forward” (from the seated driver's point of view) and when the driver is driving “forward” (from the seated driver's point of view) and the steering wheel is turned to the right (i.e., clockwise from the driver's point of view), for example, the vehicle turns right (from the seated driver's point of view) regardless of the direction in which the seat is facing.

The driver operated input controls that are not direction dependent such as the inchbrake, operate in the same manner regardless of which longitudinal direction the seat is facing in.

It is contemplated to include the dozer mode or control reversal switch 272 as part of the seat assembly 22 so that when the seat is swiveled 180 degrees, the switch 272 is automatically toggle to the correct position by the movement of the seat assembly.

The inchbrake 256 may be a foot controlled pedal-type potentiometer that is electrically communicated to the DC to DC power supply and sends an analog input voltage signal to the controller 250. This signal varies depending on how much the inchbrake is depressed. When the inchbrake 256 is fully extended (i.e., not depressed at all), the input voltage from the inchbrake 256 to the controller 250 is equal to zero volts. In this position, the inchbrake has no slowing or braking effect on the vehicle 10. When the inchbrake 256 is fully depressed, the input voltage from the inchbrake 256 to the controller 250 is equal to approximately 10.8 volts. This input voltage causes the electronic controller 250 to destroke the pumps 178, 180, which stops the movement of vehicle. The more the inchbrake 256 is depressed, the more the controller attenuates the drive signals to the pumps 178, 180 of the three motors. The inchbrake reduces the pump 178, 180 outputs by an amount directly proportional to the amount the inchbrake has been depressed.

The inchbrake 256 can be used to limit the speed of the vehicle which is advantageous in certain work situations. For example, if the vehicle operator wants to slow the vehicle down (or stop the vehicle) for some reason, the driver would partially (of fully) the press the inchbrake 256. If the inchbrake 256 is partially depressed, the controller 250 slows the vehicle (for the given FNR lever setting) in direct proportion to the amount the inchbrake 256 has been depressed. If the inchbrake 256 is fully depressed the controller 250 stops the vehicle.

The inchbrake 256 also acts as a safety feature. If the engine 172 is running at, for example, 3000 rpm and the vehicle is traveling at 1.2 mph, and the operator wants to slow the vehicle to 0.25 mph, for example, the operator depresses the inchbrake 256 through its range of motion until this speed is reached. The engine 172 remains at the same rpm level (3,000 rpm), but the pumps 178, 180 are stroked less. The inchbrake basically functions to reduce the vehicle 10 speed percent that was calculated from the position of the FNR lever 252. For example, if the FNR lever 252 is in the sixth “gear” position which indicates a 99 percent forward speed, and the inchbrake is depressed through 50% of its range of motion, the vehicle 10 travels at roughly half this speed, or at 49.5 percent of its maximum forward speed.

The pressure adjustment switch 260 is preferably a 3-position switch. The baseline pressure setting adjustment switch 260 allows the vehicle operator to either increase or decrease the minimum pressure setting in both suspension assemblies 164 simultaneously. When the vehicle 10 is started, a default (or initialization) value of Pmin is utilized by the controller 250. That is, the controller 250 operates the suspension assemblies 164 at the default value of Pmin during straight ahead (forward or reverse) vehicle operations. If the operator moves the pressure adjustment switch 260 from its neutral position into its pressure increasing position, the controller 250 raises Pmin by a predetermined amount. The pressure adjustment switch 260 has to be returned to zero and moved back into its pressure increasing position to again raise Pmin by the predetermined amount. The vehicle 10 operates with the new Pmin until either the vehicle 10 is turned off or until the operator changes this value again with the pressure adjustment switch 260. The electronic controller 250 uses the new value of Pmin for all calculations and adjustments necessary to operate the vehicle 10 (including for all calculations required to change pressure from Pmin to Pmax proportionately during steering) to execute the flow charts of FIGS. 12 and 13 and so on). The pressure adjustment switch 260 has no effect on the value of Pmax. More specifically, in the example vehicle 10, the operator is not able to adjust Pmax.

The backup alarm 308 is actuated by the controller 250 when the controller detects that the FNR lever 252 is in its reverse direction. The backup alarm 308 sounds an audible and/or visual warning signal (using, for example, a horn or warning lights or both on the vehicle) to alert persons in the vicinity of the vehicle that the vehicle is moving in reverse.

The symmetrical shape of the vehicle allows it operate in essentially the same manner with the driver (and the driver's seat) facing in either direction. As mentioned, the seat can be rotated 180 degrees to face toward either end of the vehicle. Implements can be mounted on both ends of the vehicle. For example, when the vehicle is used in as a bulldozer-type vehicle, a bucket loader can be mounted on the front and a bulldozer blade on the back of the vehicle. When used as an agricultural-type vehicle, a mower can be mounted on the front of the vehicle and a second implement mounted on the front.

The cockpit 20 includes controls the vehicle operator can use to monitor the diesel engine. The cockpit includes an oil pressure indicator, an amp meter, a temperature indicator, a tachometer, an hour meter and a battery charge indicator for the vehicle electrical system (not shown). The cockpit 20 also includes the control reversal switch 272 and the increase/decrease Pmin setpoint switch 260.

The cockpit 20 may also includes a parking brake applied switch (not shown) that may be in the form of a single pole single throw switch. The parking brake applied switch can be connected as an input to the electronic controller 250, or can be on a separate electrical circuit that is connected to the parking brake directly. This parking brake applied switch allows the operator to set the spring applied pressure released brake 201 by flipping the parking brake applied switch without shutting off the engine 172. The parking brake applied switch controls the solenoid 203 operatively associated with the brake 201 to move the brake between locking and releasing positions to thereby lock and release the drive wheel 128 on the track 26.

The cockpit 20 can optionally include a plugged hydraulic filter output indicator. The electronic controller 250 can be programmed such that if one of the filters 190, 194, 196 is plugged, an indicator indicates to the operator that the filter is plugged. Optionally, the electronic controller 250 can be programmed to shut the engine 172 off in the event of filter blockage.

The flowcharts of FIGS. 12 and 13 describe the best mode and preferred embodiment of the vehicle 10, but many structural and operational variations thereof are contemplated and within the scope of the present invention. By “operational variations” it is meant that the controller 250 can be programmed to control the vehicle in many different ways.

The foregoing discussion of the electronic control system and flowcharts provide an understanding of the logic that is used to operate the vehicle. This description can be used to write a program of instructions for the electronic controller 250 to control operation of the vehicle 10. The controller 250 can be any general purpose computer that includes a central processor, processor-accessible memory (for storing programs and data) and data input and output capability. In the example vehicle, this logic was implemented using ladder logic methodology.

It can thus be appreciated that the objectives of the present invention have been fully and effectively accomplished. It is to be understood, however, that the foregoing preferred embodiment has been provided solely to illustrate the structural and functional principles of the present invention and is not intended to be limiting. To the contrary, the present invention is intended to encompass all the modifications, alterations, and substitutions within the spirit and scope of the appended claims.

1. A vehicle comprising:
a frame assembly;
an engine assembly carried by said frame assembly constructed and arranged to generate and supply power;
a driving track assembly including a track frame structure forming a part of said frame assembly, a series of rollers carried by said track frame structure including a driver roller and an endless track trained about said rollers so as to provide an operative ground engaging flight extending in a straight vehicle driving direction;
a power operated track moving structure is operatively connected to said driver roller using power supplied from the engine assembly to move said track in driving relation to the ground;
a pair of driving and steering wheels disposed on opposite sides of said track assembly in flanking relation thereto;
a wheel mounting assembly for each wheel including wheel mounting structure constructed and arranged to mount an associated wheel for rotational movement about a generally transversely horizontally extending rotational axis and a parallel linkage mechanism operatively connected with said frame assembly extending laterally outwardly in connected relation to said wheel mounting structure constructed and arranged to enable said wheel mounting structure to be vertically moved in such a way as to effect a vertical translational movement of said rotational axis;
a power operated wheel driving structure operatively connected with each wheel using power supplied by said engine assembly to rotate an associated wheel about the rotational axis thereof;
a power operated retractable and extendible unit operatively connected between said track frame structure and each wheel constructed and arranged to effect a relative vertical movement of an associated wheel with respect to said track frame structure between retracted and extended positions;
a manually operated speed determining mechanism carried by said frame assembly constructed and arranged to be moved manually between a dead position wherein said track assembly and wheels are not moved and speed positions wherein said track assembly and said wheels are caused to be moved;
a manually operated steering and signal generating mechanism carried by said frame assembly constructed and arranged to be manually moved between a straight position wherein a straight steering signal is generated and said wheels are caused to move said vehicle in a straight direction, and opposite turning positions wherein turning steering signals are generated and said wheels are caused to turn said vehicle in a selected direction at a selected angle;
an electronic controller operable to receive the steering signals generated by said steering and signal generating mechanism and to responsively control the power supplied from said engine assembly to said retractable and extensible units to move said wheels between said retracted and extended positions and effect a load shift between said wheels and said track assembly so that (1) when a straight steering signal is received said wheels are moved into a retracted position wherein said wheels and the entire operative flight of said endless track are in ground engagement and share the load to provide maximum traction and (2) when a turning steering signal is received said wheels are moved into an extended position wherein said wheels and only a portion of the operative flight of the endless track are in ground engagement to facilitate turning movement.

2. A vehicle as defined in claim 1, wherein each of said retractable and extendible units is a hydraulic piston and cylinder unit and the power to effect movements thereof constitutes the power of the flow of hydraulic fluid under pressure generated by a pump driven by said engine assembly into and out of a load bearing chamber of each of said hydraulic piston and cylinder units.

3. A vehicle as defined in claim 2, wherein the flow of hydraulic fluid under pressure into and out of each of said load bearing chambers of said piston and cylinder units is accomplished by a control valve commanded by said controller in response to the steering signals received thereby to maintain a commanded load pressure within each of said piston and cylinder units indicative of a desired wheel position.

4. A vehicle as defined in claim 3, wherein each of said control valves is also pressure responsive to a rapid pressure change in the load pressure in the load bearing chamber of the associated piston and cylinder unit occasioned by the associated wheel moving over a depression or projection in an otherwise even ground condition to allow flow of hydraulic fluid to or from the associated load chamber to lower and raise the associated wheel to rotate through the depression or raise and lower the associated wheel to rotate over the projection.

5. A vehicle as defined in claim 4, wherein a position sensor is associated with each piston and cylinder unit constructed and arranged to generate a position signal indicative of the actual position of the associated wheel, said controller being operable to receive a position signal from each position sensor to determine whether the actual wheel position is equal to the desired wheel position for each wheel.
